(19) United States
(12) Patent Application Publication
(10) Pub. No.: US 2008/0014373 A1
(43) Pub. Date: Jan. 17, 2008

(54) Optical Film, Producing Method Therefor, Polarizing Plate and Image Display Apparatus

(76) Inventors: Yuuzou Muramatsu, Minami-Ashigara-shi (JP); Kenichi Nakamura, Odawara-shi (JP)

Correspondence Address: BUCHANAN, INGERSOLL & ROONEY PC, POST OFFICE BOX 1404, ALEXANDRIA, VA, 22313-1404, US

(21) Appl. No.: 11/597,548

(22) PCT Filed: Jul. 28, 2005
(86) PCT No.: PCT/JP05/14250

§ 371 Date: Nov. 27, 2006

(30) Foreign Application Priority Data
Aug. 2, 2004 (JP) 2004-225279
Dec. 16, 2004 (JP) 2004-364096

(51) Int. Cl. C09K 19/02; B32B 23/00

(52) U.S. Cl. 428/1.1; 428/98

(57) ABSTRACT

An optical film includes an antistatic film comprising at least an electroconductive material and cellulose acylate.

### TECHNICAL FIELD

The present invention relates to an optical film, a producing method therefor, a polarizing plate and an image display apparatus.

### BACKGROUND ART

Recently, image display apparatuses provided with various optical films (such as an antireflection film or an antiglare film) are increasing.

For example, an antireflection film or an antiglare film is generally provided in various image display apparatuses such as a liquid crystal display apparatus (LCD), a plasma display panel (PDP), an electroluminescent display (ELD) or a cathode ray tube display apparatus (CRT) on an outermost surface of such display in order to prevent a loss in contrast, resulting from a reflection of an external light or a reflection of an image.

Such optical film is required to have a high physical strength (such as scratch resistance), a transparency, a chemical resistance, and a weather resistance (such as humidity-heat resistance and light fastness). Also there is required a measure for preventing deposition, on the surface of the optical film, of particles (such as dusts) which deteriorate the visibility of the display.

In order to provide the optical film with a high physical strength, it is already known to form a hard coat film on the optical film.

Also as a measure to for preventing deposition, on the surface of the optical film, of particles (such as dusts) which deteriorate the visibility of the display, it is already known to form an antistatic film on the optical film.

In case of preparing an antistatic film by a coating method, an electroconductive material for example conductive inorganic fine particles (such as of antimony-doped tin oxide (ATO) or tin-doped indium oxide (ITO)) is usually included in such antistatic film (cf. JP-A No. 6-123086, JP-A No. 2002-311208, JP-A No. 2003-39586, JP-A No. 2003-292826 and JP-A No. 2003-327430).

Also in a liquid crystal display apparatus, a polarizing plate is an indispensable material and generally has a structure in which a polarizing film is protected by two protective films. By providing such protective film with an antireflective function or an antiglare function, there can be realized a significant cost reduction and a thinner configuration of the display apparatus.

On the other hand, the protective film employed in the polarizing plate is required to have a sufficient adhesive property for achieving an adhesion with the polarizing film. For improving the adhesion with the polarizing film, there is usually employed a method of saponifying the protective film and hydrophilizing the surface of the protective film.

### DISCLOSURE OF THE INVENTION

Formation of an antistatic film on an optical film is effective for preventing a stain or dust deposition, but the presence of the antistatic film, containing a conductive material (such as conductive inorganic fine particles) on the hard coat film may deteriorate the scratch resistance of the optical film.

On the other hand, the conductive material (such as conductive inorganic fine particles) is usually colored. Also the hard coat layer usually has a thickness of 1 μm or larger, and, in order to provide the hard coat film with an antistatic property by including the conductive material therein, there is required a large amount of the conductive material, thereby deteriorating the transparency (optical transmittance) of the optical film. Also since the conductive material is relatively expensive, such large amount of the conductive material results in an increased cost.

Therefore, the antistatic film is preferably provided with a small thickness between the transparent substrate and the hard coat film.

In the preparation of a hard coat film for use in an optical film, there is usually employed a binder curable with an ionizing radiation.

However, following drawbacks are found in an investigation for providing the antistatic film between the transparent substrate and the hard coat film.

In case of forming an antistatic film on a transparent substrate constituted of cellulose acylate, a peeling failure is often generated between the layers of the transparent substrate, the antistatic film and the hard coat film.

Also a hard coat film formed on the antistatic film reduces the antistatic effect on the surface of the optical film, thereby deteriorating the antidust property. Such deterioration of the antidust property becomes more conspicuous as the thickness of the hard coat film increases.

Also in case a transparent substrate is produced by a producing machine, then once wound up and an antistatic film and a hard coat film are coated on such substrate in another coating machine, the optical film cannot be produced inexpensively.

An object of the present invention is to provide an optical film which has an antistatic film, but is not accompanied with the above-mentioned drawbacks, by inter alia solving such drawbacks associated with the formation of an antistatic film between a transparent substrate and a hard coat film, to provide an optical film showing an excellent mutual adhesion among a transparent substrate constituted of cellulose acylate, an antistatic film and a hard coat film, and having excellent physical properties such as an antidust property and a scratch resistance.

Another object is to mass produce an optical film, having the aforementioned excellent properties, inexpensively.

Still another object is to provide a polarizing plate and an image display apparatus having an optical property such as an antireflection property or an antiglare property and excellent in the aforementioned properties.

The aforementioned objectives can be attained by an optical film, a producing method for an optical film, a polarizing plate, and an image display apparatus of following configurations:

(1) An optical film including an antistatic film comprising at least an electroconductive material and cellulose acylate.

(2) An optical film described in (1), wherein the antistatic film is laminated on a transparent substrate principally comprising cellulose acylate.

(3) An optical film described in (1), wherein the antistatic film is laminated by a co-casting method as a part of a substrate principally comprising cellulose acylate.

(4) An optical film described in (1), wherein the antistatic film and a hard coat film are laminated in this order on a transparent substrate principally comprising cellulose acylate.

(5) An optical film described in any one of (1) to (4), wherein the cellulose acylate is cellulose acetate.

(6) An optical film described in (5), wherein the cellulose acetate has a substitution degree of 2.0 to 3.0.

(7) An optical film described in any one of (1) to (6), wherein the electroconductive material includes an inorganic compound containing at least an element selected from tin, indium, antimony and zinc.

(8) An optical film described in (7), wherein the electroconductive material includes at least an inorganic compound selected from antimony-doped tin oxide (ATO), tin-doped indium oxide (ITO), aluminum-doped zinc oxide (AZO), fluorine-doped tin oxide (FTO), zinc-doped indium oxide (IZO), tin oxide, antimony oxide and indium oxide.

(9) An optical film described in any one of (1) to (8), wherein the electroconductive material has an average particle size of 1 to 200 nm.

(10) An optical film described in any one of (1) to (9), wherein the electroconductive material has a specific surface area of 1 to 400 m²/g.

(11) An optical film described in any one of (1) to (10), wherein the electroconductive material is subjected to a surface treatment with an organometallic compound.

(12) An optical film described in any one of (1) to (11), wherein the electroconductive material is dispersed with a dispersant.

(13) An optical film described in (12), wherein the dispersant is an anionic or nonionic dispersant.

(14) An optical film described in any one of (1) to (13), wherein the antistatic film includes a compound having a crosslinkable or polymerizable functional group.

(15) An optical film described in (14), wherein the crosslinkable or polymerizable functional group is a functional group showing a crosslinking or polymerizing property by heat or a light.

(16) An optical film described in (14) or (15), wherein a binder of the antistatic film is a cured substance of a compound having a functional group showing a crosslinking property with cellulose acylate or a polymerizing property.

(17) An optical film described in any one of (1) to (16), wherein the antistatic film has a surface resistivity equal to or less than 1×10¹⁴ Ω/sq.

(18) An optical film described in any one of (1) to (16), wherein the antistatic film has a surface resistivity equal to or less than 1×10¹² Ω/sq.

(19) An optical film described in any one of (1) to (18), wherein a hard coat film is laminated on the antistatic film and comprises conductive particles of an average particle size of 0.2 to 10 μm.

(20) An optical film described in (19), wherein a following value S, indicating a particle size distribution of the conductive particles having the average particles size of 0.2 to 10 μm, is equal to or less than 2.0:
S=[D(0.9)−D(0.1)]/D(0.5)
wherein:

D(0.1): a value at 10% of a cumulative volume-converted particle size distribution;

D(0.5): a value at 50% of a cumulative volume-converted particle size distribution; and

D(0.9): a value at 90% of a cumulative volume-converted particle size distribution.

(21) An optical film described in (20), wherein the value S is equal to or less than 1.0.

(22) An optical film described in any one of (19) to (21), wherein the conductive particles having the average particles size of 0.2 to 10 μm are particles having an electroconductive compound on a surface of particles of an organic compound or an inorganic compound.

(23) An optical film described in any one of (19) to (22), wherein the conductive particles having the average particles size of 0.2 to 10 μm are particles having an electroconductive metal on a surface of particles of an organic compound or an inorganic compound.

(24) An optical film described in any one of (19) to (23), wherein the conductive particles having the average particles size of 0.2 to 10 μm have an average particle size equal to or larger than 30% of a thickness of the hard coat film.

(25) An optical film described in any one of (2) and (4) to (24), wherein the antistatic film and/or the hard coat film is provided by a coating method selected from a wire bar coating, a gravure coating and a die coating.

(26) An optical film described in (24), wherein the antistatic film and/or the hard coat film provided by a die coating method.

(27) An optical film described in any one of (1) to (26), wherein a solvent contained in a composition for forming the antistatic film and/or the hard coat film contains, as a principal component, a solvent capable of dissolving cellulose acylate contained in the transparent substrate and/or the antistatic film.

(28) An optical film described in (27), wherein the solvent capable of dissolving cellulose acylate contained in the transparent substrate and/or the antistatic film is a ketone solvent, a halogenated hydrocarbon solvent, an ester solvent or a mixture thereof.

(29) An optical film described in any one of (1) to (28), wherein a film composition (the hard coat film), formed by coating and curing a hard coat film coating composition, contains an ethylenic unsaturated group-containing polyester dendrimer (A), which is a reaction product of a polyester polyol dendrimer compound (a) having 6 or more hydroxyl groups in a molecule and an ethylenic unsaturated group-containing monocarboxylic acid (b), by 10 to 80 mass % calculated as a solid content.

(30) An optical film described in any one of (1) to (29), wherein the antistatic film and/or the hard coat film is formed in an atmosphere having an oxygen concentration equal to or less than 10 vol. %.

(31) An optical film described in any one of (1) to (29), wherein the antistatic film and/or the hard coat film is formed in an atmosphere having an oxygen concentration equal to or less than 4 vol. %.

(32) An optical film described in (30) or (31), wherein the atmosphere having an oxygen concentration equal to or less 10 vol. %, or equal to or less than 4 vol. % is formed by eliminating other gasses by a nitrogen replacement (nitrogen purging).

(33) An optical film described in any one of (1) to (32), wherein the optical film is an antistatic film, an antiglare film, a light diffusing film or an antireflection film.

(34) An optical film described in any one of (1) to (32), wherein a surface thereof at the side of the antistatic film has a surface resistivity equal to or less than 1×10¹⁴ Ω/sq.

(35) An optical film described in any one of (1) to (33), wherein a surface thereof at the side of the antistatic film has a surface resistivity equal to or less than 1×10¹² Ω/sq.

(36) An optical film described in any one of (1) to (35), wherein at least a surface thereof is subjected to a saponification process.

(37) An optical film described in any one of (1) to (36), wherein a surface of the cellulose acylate film opposite to a side having the antistatic film has a contact angle to water equal to or less than 40°.

(38) An optical film producing method of producing an optical film according to any one of (1) to (37).

(39) An optical film producing method described in (38), wherein an optical film described in any one of (1) to (35) is subjected to a saponification process.

(40) An optical film producing method described in (38) or (39), wherein the antistatic film is laminated on a transparent substrate principally constituted of cellulose acylate.

(41) An optical film producing method described in (38) or (39), wherein the antistatic film is laminated by a co-casting method as a part of the substrate principally constituted of cellulose acylate.

(42) An optical film producing method described in (40), wherein the antistatic film and/or the hard coat film provided by a die coating method.

(43) A polarizing plate including a polarizing film and two protective films provided on both sides of the polarizing film, wherein an optical film described in any one of (1) to (37) is employed as at least one of the protective films.

(44) A polarizing plate including a polarizing film and two protective films provided on both sides of the polarizing film described in (43), wherein an optical film described in any one of (1) to (37) is employed as one of the protective films and an optical compensation film having an optically anisotropic layer is employed as the other of the protective films.

(45) A polarizing plate described in (44), wherein the optical compensation film has an optically anisotropic layer formed by a compound having a discotic structural unit, that a disc plane of the discotic structural unit is inclined to the film surface, and that an angle formed by the disc plane of the discotic structural unit and the film surface changes in a direction of depth of the optically anisotropic layer.

(46) An image display apparatus wherein an optical film described in any one of (1) to (37) or a polarizing plate described in any one of (43) to (45) is provided on an image display surface.

(47) An image display apparatus described in (46), wherein it is a liquid crystal display apparatus in which, among two polarizing plates provided on both sides of a liquid crystal cell, a polarizing plate described in any one of (43) to (45) is employed as the polarizing plate of a display side, and that an optical film used as a protective film of the polarizing plate is provided at an opposite side of the liquid crystal cell, with respect to the polarizing film.

(48) An image display apparatus described in (45) or (46) wherein the image display apparatus is a transmission type, reflective type or semi-transmission type liquid crystal display apparatus of TN, STN, IPS, VA or OCB mode.

The present invention is characterized in that an optical film has basically an antistatic film comprising a conductive material and cellulose acylate, inter alia the antistatic film is a part of a substrate or is positioned between a substrate and a hard coat film. Properties such as a scratch resistance and adhesion between layers are improved with the antistatic film. Further, a polarizing plate and an image display element utilizing such optical film using the antistatic film attain the objects of the invention and provide following effects of the present invention.

### BRIEF DESCRIPTION OF THE DRAWINGS

FIGS. 1A and 1B are schematic cross-sectional views showing a layer structure in two embodiments of an optical film of the invention, having an excellent antireflective property.

FIG. 2A is a schematic cross-sectional view showing a layer structure in an embodiment of an optical film of the invention, having an antiglare property;

FIG. 2B is a schematic cross-sectional view showing a layer structure in an embodiment of an optical film of the invention, having a light diffusing property;

FIG. 3A is a schematic cross-sectional view showing an embodiment of application of the optical film of the invention to an image display apparatus;

FIG. 3B is a schematic cross-sectional view showing an embodiment of application of the optical film of the invention to a liquid crystal display apparatus;

FIG. 4C is a schematic cross-sectional view showing an embodiment of application of the optical film of the invention to a liquid crystal display apparatus; and

FIG. 4D is a schematic cross-sectional view showing an embodiment of application of the optical film of the invention to a liquid crystal display apparatus.

1 denotes a transparent substrate; 2 denotes an antistatic layer; 3 denotes a hard coat layer; 4 denotes a low refractive index layer (outermost layer); 5 denotes a medium refractive index layer; 6 denotes a high refractive index layer; 7 denotes an antiglare layer; 8 denotes particles with an average particle size of 0.2-10 μm; 9 denotes conductive particles with an average particle size of 0.2-10 μm; 10 denotes an adhesive layer; 11 denotes a protective film for polarizing film; 12 denotes a protective film for polarizing film; 13 denotes a polarizing film; and 14 denotes a light diffusing layer.

### BEST MODE FOR CARRYING OUT THE INVENTION

In the following the present invention will be described in detail. In the present specification, in case a numerical value represents a physical property or a characteristic value, an expression “(numerical value 1)−(numerical value 2)” means “equal to or larger than (numerical value 1) but equal to or smaller than (numerical value 2)”. Also an expression “(meth)acryloyl” means “acryloyl and/or methacryloyl”. Descriptions such as “(meth)acrylate”, “(meth)acrylic acid” and the like are to be construed in a similar manner.

(Electroconductive Material)

In the invention, a conductive material preferably employed in an antistatic film (hereinafter represented as antistatic layer) is preferably a conductive material of electron conduction type such as a π-conjugate conductive organic compound or conductive fine particles.

The π-conjugate conductive organic compound can be an aliphatic conjugate compound such as polyacetylene, an aromatic conjugate compound such as poly(paraphenylene), a heterocyclic conjugate compound such as polypyrrole or polythiophene, a heteroatom conjugate compound such as polyanyline, or a mixed conjugate compound such as poly(phenylenevinylene).

The conductive fine particles can be those base on carbon, a metal, a metal oxide or those coated with a conductive material.

The carbon-based fine particles can be carbon powder such as carbon black, ketzen black, or acetylene black, carbon fibers such as PAN-based carbon fibers or pitch-based carbon fibers, or carbon flakes such as crushed graphite.

The metal-based fine particles can be powder of a metal such as aluminum, copper, gold, silver, nickel, chromium, iron, molybdenum, titanium, tungsten, or tantalum, or an alloy containing such metal, metal flakes, or metal fibers of iron, copper, stainless steel, silver-plated copper or brass.

The metal oxide-based fine particles can be fine particles of a metal oxide containing zinc (Zn), tin (Sn), indium (In), antimony (Sb), or cerium (Ce).

In particular, aluminum-doped zinc oxide (AZO), tin oxide (SnO₂), antimony-doped tin oxide (ATO), fluorine-doped tin oxide (FTO), indium oxide (In₂O₃), zinc-doped indium oxide (IZO), tin-doped indium oxide (ITO), or antimony oxide (Sb₂O₃) is more preferable and AZO, ATO, SnO₂, In₂O₃ or ITO is most preferable.

The conductive material-coated fine particles can be fine particles for example of titanium oxide (spherical or acicular), potassium titanate, aluminum borate, barium sulfate, mica, silica, polystyrene, acrylic resin, epoxy resin, polyamide resin or polyurethane resin of which surface is treated with a metal oxide (such as AZO, SnO₂, ATO, FTO, In₂O₃, IZO, ITO or Sb₂O₃), or a metal (such as gold and/or nickel).

As the conductive material of the antistatic layer, there is preferred a π-conjugate conductive organic compound (particularly a polythiophene conductive polymer), conductive fine particles of a metal (particularly gold, silver, silver/palladium alloy, copper, nickel or aluminum) or metal oxide fine particles (particularly AZO, SnO₂, ATO, FTO, In₂O₃, IZO, ITO or Sb₂O₃). There is particularly preferred a conductive material of electron conductive type such as a metal or a metal oxide, further preferably metal oxide fine particles.

Primary particles of the conductive material preferably has a mass-averaged particle size of 1-200 nm, more preferably 1-150 nm, further preferably 1-100 nm, and particularly preferably 1-80 nm. The average particle size of the conductive material can be measured by a light scattering method or an electron photomicrograph.

The conductive material preferably has a specific surface area of 10-400 m²/g, more preferably 20-200 m²/g, and most preferably 30-150 m²/g.

The conductive material preferably has a granular, spherical, cubic, spindle-like, flake, acicular or amorphous shape, particularly preferably an amorphous, acicular or flake shape.

In order to improve the dispersibility in the antistatic layer, the conductive material is preferably subjected to a surface treatment with various organometallic compounds. The organometallic compound can be a silane coupling agent, a titanate coupling agent, an aluminum coupling agent and/or a derivative thereof. Particularly preferred is a silane coupling agent represented by a following general formula (a) and/or a derivative thereof
(R¹⁰)ₛ—Si(Z)₄₋ₛ general formula (a)

In the general formula (a), R¹⁰ represents a substituted or non-substituted alkyl group or a substituted or non-substituted aryl group. The alkyl group can be methyl, ethyl, propyl, isopropyl, t-butyl, sec-butyl, hexyl, decyl, or hexadecyl. The alkyl group preferably has 1-30 carbon atoms, more preferably 1-16 carbon atoms and particularly preferably 1-6 carbon atoms. The aryl group can be phenyl or naphthyl, preferably a phenyl group.

Z represents a hydroxyl group or a hydrolysable group, such as an alkoxy group (preferably an alkoxy group with 1-5 carbon atoms, such as a methoxy group or an ethoxy group), a halogen atom (such as Cl, Br or I), or R¹²COO(R¹² being preferably a hydrogen atom or an alkyl group with 1-5 carbon atoms, such as CH₃COO or C₂H₅COO), preferably an alkoxy group and particularly preferably a methoxy group or an ethoxy group.

s represents an integer of 1-3, preferably 1 or 2, and particularly preferably 1.

In case R¹⁰ or Z is present in plural units, plural R¹⁰s or Zs may be mutually different.

The substituent contained in R¹⁰ is not particularly restricted, and can be a halogen atom (such as fluorine, chlorine or bromine), a hydroxyl group, a mercapto group, a carboxyl group, an epoxy group, an alkyl group (such as methyl, ethyl, i-propyl, propyl, or t-butyl), an aryl group (such as phenyl or naphthyl), an aromatic heterocyclic group (such as furyl, pyrazolyl or pyridyl), an alkoxy group (such as methoxy, ethoxy, i-propoxy, or hexyloxy), an aryloxy group (such as phenoxy), an alkylthio group (such as methylthio or ethylthio), an arylthio group (such as phenylthio), an alkenyl group (such as vinyl or 1-propenyl), an alkoxysilyl group (such as trimethoxysilyl or triethoxysilyl), an acyloxy group (such as acetoxy, acryloyloxy or methacryloyloxy), an alkoxycarbonyl group (such as methoxycarbonyl or ethoxycarbonyl), an aryloxycarbonyl group (such as phenoxycarbonyl), a carbamoyl group (such as carbamoyl, N-methylcarbamoyl, N,N-dimethylcarbamoyl or N-methyl-N-octylcarbamoyl), or an acylamino group (such as acetylamino, benzoylamino, acryloylamino or methacryloylamino), and such substituent may be substituted with another substituent.

Among these, there is further preferred a hydroxyl group, a mercapto group, a carboxyl group, an epoxy group, an alkyl group, an alkoxysilyl group, an acyloxy group, or an acylamino group. There is particularly preferred a crosslinkable or polymerizable functional group, particularly an epoxy group, a polymerizable acyloxy group ((meth)acryloyl), or a polymerizable acylamino group (acrylamino or methacrylamino). Such substituent may be substituted with another substituent.

In case R¹⁰ is present in plural units, at least one thereof is preferably a substituted alkyl group or a substituted aryl group. Within the silane coupling agent represented by the general formula (a), a silane coupling agent having a vinyl polymerizable substituent, represented by a following general formula (b) or a derivative thereof is particularly preferable:

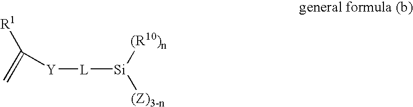

In the general formula (b), R¹ represents a hydrogen atom, a methyl group, an ethyl group, an alkoxycarbonyl group, a cyano group, a fluorine atom or a chlorine atom. The alkoxycarbon group can be a methoxycarbonyl group or an ethoxycarbonyl group. There is preferred a hydrogen atom, a methyl group, a methoxy group, a methoxycarbonyl group, a cyano group, a fluorine atom or a chlorine atom, and further preferably a hydrogen atom, a methyl group, a methoxycarbonyl group, a fluorine atom or a chlorine atom.

Y represents a single bond, *—COO—**, *—CONH—**, *—O—**, or *—NH—CO—NH—**, preferably a single bond, *—COO—**, or *—CONH—**, more preferably a single bond, or *—COO—**, and particularly preferably *—COO—**. In the foregoing, * indicates a bonding position to CH₂═C(R¹)—, and ** indicates a bonding position to L.

L represents a divalent connecting group, more specifically a substituted or non-substituted alkylene group, a substituted or non-substituted arylene group, a substituted or non-substituted alkylene group having an internal connecting group (such as ether, ester or amide), or a substituted or non-substituted arylene group having an internal connecting group, preferably a substituted or non-substituted alkylene group, a substituted or non-substituted arylene group, or a alkylene group having an internal connecting group, further preferably a non-substituted alkylene group, a non-substituted arylene group, or an alkylene group having an internal ether or ester connecting group, and particularly preferably a non-substituted alkylene group, or an alkylene group having an internal ether or ester connecting group. The substituent can be a halogen, a hydroxyl group, a mercapto group, a carboxyl group, an epoxy group, an alkyl group, or an aryl group, and such substituent may be further substituted.

n represents 0 or 1, preferably 0.

R¹⁰ has a same meaning as R¹⁰ in the general formula (a), preferably a substituted or non-substituted alkyl group, or a non-substituted aryl group, and more preferably a non-substituted alkyl group, or a non-substituted aryl group.

Z has a same meaning as Z in the general formula (a), preferably a halogen atom, a hydroxyl group, or a non-substituted alkoxy group, more preferably a chlorine atom, a hydroxyl group, or a non-substituted alkyl group with 1-6 carbon atoms, further preferably a hydroxyl group, or an alkoxy group with 1-3 carbon atoms, and particularly preferably a methoxy group. In case Z is present in plural units, the plural Zs may be mutually same or different.

The compound of the general formula (a) and the general formula (b) and derivatives thereof may be employed in a combination of two or more kinds.

In the following, specific examples of the compound represented by the general formula (a) and the general formula (b) are shown, but the present invention is not limited to such examples.

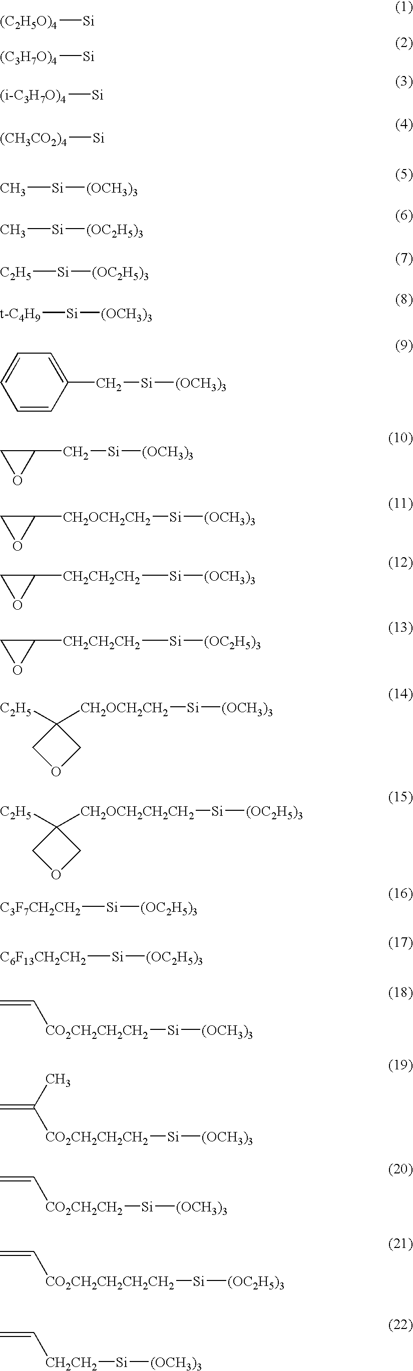

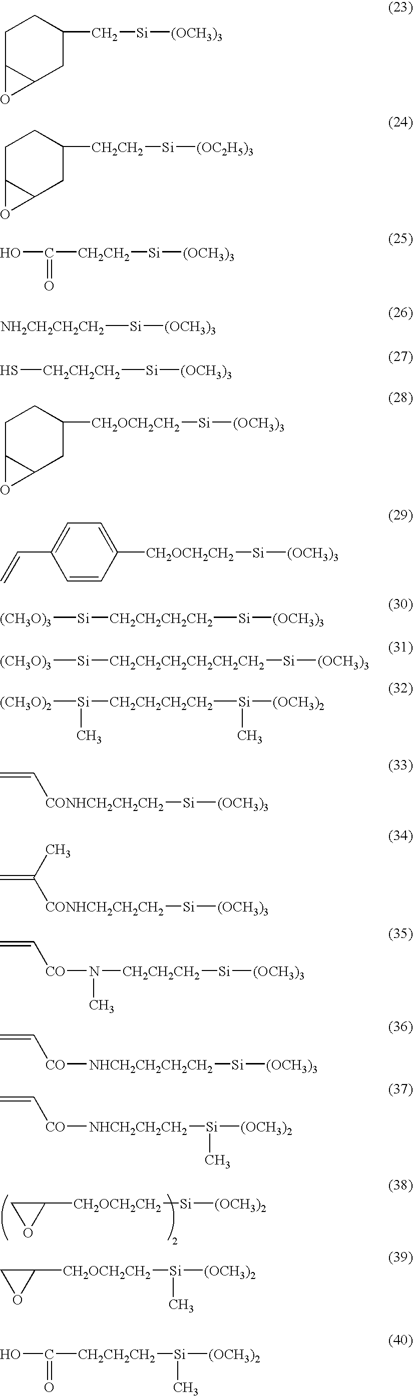

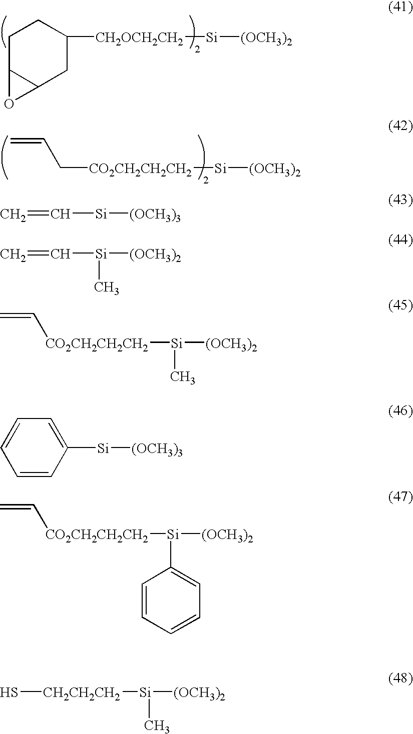

The titanate coupling agent can be, for example, a metal alkoxide such as tetramethoxy titanium, tetraethoxy titanium or tetraisopropoxy titanium, or Blenact (such as KR-TTS, KR-46B, KR-55 or KR-41B, manufactured by Ajinomoto Co.

An amount of surface treatment with such organometallic compound is preferably executed within a range 0.5-30 mass % with respect to the conductive material, more preferably 1-20 mass % and particularly preferably 2-10 mass %.

For a method of coating the conductive material with the aforementioned organometallic compound, reference may be made for example to JP-A Nos. 10-324817, 2001-26423, 2003-327430 and 2003-335979.

(Cellulose Acylate)

The cellulose acylate to be employed in the antistatic layer of the invention is preferably produced from cotton linter or wood pulp (broad leaf pulp or needle leaf pulp). Such raw material cellulose is described in detail for example in Plastic Zairyo Koza, (17) cellulosic resins (Marusawa and Uda, published by Nikkan Kogyo Shimbun, 1970).

The cellulose acylate employed in the present invention preferably has a substitution degree of cellulose to hydroxyl group, satisfying all of following relations (I) to (III):
2.0≦A+B≦3.0 relation (I)
0≦A≦3.0 relation (II):
0≦B≦3.0 relation (III):

In the foregoing, A and B represent acyl substituents substituted on the hydroxyl groups of cellulose, wherein A is a substitution degree of acetyl groups, and B is a substitution degree of acyl groups with 3 to 22 carbon atoms. Cellulose has three hydroxyl groups per a glucose unit, and the foregoing values indicate substitution levels to such hydroxyl groups, with a maximum substitution degree being 3.0. Cellulose triacetate generally has a substitution degree A of 2.6 to 3.0 (namely non-substituted hydroxyl group being present 0.4 at maximum), and B=0.

The substitution degree can be obtained by a calculation, based on a measurement of a bonding degree of acetic acid and/or fatty acid with 3-22 carbon atoms, substituting the hydroxyl groups of cellulose. The measurement can be executed according to ASTM, D-817-91.

In case all the acyl groups are acetyl groups, the substitution degree of the hydroxyl group is generally represented by an acetylation degree. The acetylation degree means an amount of bonded acetic acid, indicating a mass percentage of acetic acid bonded per unit mass of cellulose, and can be measured according to a measuring method for acetylation degree by ASTM, D-817-91 (test method for cellulose acetate etc.).

Also the substitution degree is correlated with the acetylation degree by a following general formula:
substitution degree=acetylation degree×162/[(6005−acetylation degree)×42]

An acyl group of cellulose acylate to be employed in the invention may be an aliphatic acyl group or an aromatic acyl group, and is not particularly restricted. It can for example be an alkylcarboxylate ester, an alkenylcarboxylate ester, an aromatic carboxylate ester, or an aromatic substituted alkylcarboxylate ester of cellulose, each of which may further have a substituent, and there is preferred an ester group with 22 carbon atoms or less in total.

The preferred cellulose acylate can be cellulose acylate having an acyl group with 22 carbon atoms or less in total in an ester portion (such as acetyl, propionyl, butyloyl, valyl, heptanoyl, octanoyl, decanoyl, dodecanoyl, tridecanoyl, hexadecanoyl, or octadecanoyl), an aryl carbonyl group (such as acryl or methacryl), an aromatic acyl group (such as benzoyl or naphthaloyl), or a cinnamoyl group. Among these, there is particularly preferred cellulose acetate, cellulose acetate propionate (CAP), cellulose acetate butyrate (CAB), cellulose acetate stearate or cellulose acetate benzoate.

There is also preferably employed cellulose acylate in which a crosslinkable or polymerizable functional group, more preferably cellulose acylate having a functional group capable of crosslinking or polymerization by a light, heat, an electron beam or a radiation, particularly preferably cellulose acylate having a functional group capable of crosslinking or polymerization by a light or heat.

The crosslinkable or polymerizable functional group can be an ethylenic unsaturated group capable of a crosslinking reaction or a polymerization reaction by radical species (such as a (meth)acryloyl group, an allyl group, a styryl group, or a vinyloxy group), a cationic polymerizable group (such as an epoxy group, an oxatanyl group or a vinyloxy group), a condensation polymerizable group (such as a hydrolysable silyl group or an N-methylol group), an aziridine group, or an isocyanate group. The preferable functional group is a (meth)acryloyl group, an allyl group, an epoxy group, or an isocyanate group, and particularly preferably a (meth)acryloyl group or an isocyanate group.

Cellulose acylates preferred in the invention are described for example in JP-A Nos. 57-182737, 4-277530, 8-231761, 9-40792, 9-90101, 10-45803, 10-60170, 11-5851, 11-269304, 11-269304, 11-292989, 12-131524 and 12-137115.

Among the cellulose acylates, particularly preferable is cellulose acetate, with a substitution degree preferably of 2.0-3.0, more preferably 2.2-3.0 and particularly preferably 2.4-2.95. There is preferred so-called cellulose triacetate (TAC) or cellulose diacetate (DAC).

Commercially available products include cellulose acylates of Daicel Chemical Industries Ltd. (such as LM-80, L-20, 30, 40, 50, 70 or LT-35, 55 or 105), Eastman Chemical Co. (such as CAB-551-0.01, CAB-551-0.02, CAB-500-5, CAB-381-0.5, CAB-381-02, CAB-381-20, CAB-321-0.2, CAP-504-0./2, CAP-482-20, or CA-398-3), or those of Courtaulds or Hoechst.

The cellulose acylate has a viscosity-averaged polymerization degree of 100 to 700, preferably 120 to 500, more preferably 130 to 400, further preferably 140 to 400 and particularly preferably 150 to 380.

The viscosity-averaged polymerization degree can be measured by a limit viscosity method of Uda et al. (Kazuo Uda and Hideo Saito, Journal of the Society of Fiber Science and Technology, vol. 18, No. 1, 105-120 (1962). It is also described in detail in JP-A No. 9-95538. The viscosity-averaged polymerization degree is determined by a following equation from an intrinsic viscosity [η] of cellulose acylate measured with an Ostwald's viscosimeter:
DP=[η]/Km (a1)
in which [η] is the intrinsic viscosity of cellulose acylate, and Km is a constant 6×10⁻⁴.

In case the viscosity-averaged polymerization degree (DP) is equal to larger than 290, the viscosity-averaged polymerization degree and a viscosity (η) of a concentration solution measured by a ball-falling viscosity preferably satisfy a following relationship (a2):
2.814×ln(DP)−11.753≦ln(η)≦6.29×ln(DP)−31.469 (a2)
wherein DP is the viscosity-averaged polymerization degree equal to or higher than 290, and η is a passing time (seconds) between marker lines in the ball-falling viscosity measuring method. The aforementioned relation (a2) is calculated from a plotting of the viscosity-averaged polymerization degree and the viscosity in a concentrated solution.

Also the cellulose acylate to be employed in the present invention preferably has a narrow molecular weight distribution represented by Mw/Mn (Mw: mass-averaged molecular weight, Mn: number-averaged molecular weight) measured by a gel permeation chromatography. More specifically, Mw/Mn is preferably within a range of 1.0 to 5.0, more preferably 1.0 to 4.0 and particularly preferably 1.5 to 3.5.

The cellulose acylate preferably has a glass transition temperature (Tg) of 70-200° C., and more preferably 100-180° C.

(Antistatic Film)

The antistatic film of the invention (hereinafter represented as antistatic layer) is characterized in including the conductive material and the cellulose acylate described above. The antistatic layer of the invention will be detailedly explained in the following.

Formation of an antistatic layer on a transparent substrate (cellulose acylate film) prevents deposition of particles (such as dusts) on the surface of the transparent substrate, thereby exhibiting an excellent antidust property. The antidust property is exhibited by reducing a surface resistivity of the transparent substrate, and becomes more prominent as the surface resistivity becomes lower.

In the optical film of the invention, a surface resistivity on a surface of the side of the antistatic layer is preferably 1×10¹⁴ Ω/sq. or less, more preferably 1×10¹² Ω/sq. or less, further preferably 1×10¹¹ Ω/sq. or less, particularly preferably 1×10⁹ Ω/sq. or less, and most preferably 1×10⁸ Ω/sq. or less.

A thickness of the antistatic layer can be selected suitably according to the application. In case of preparing an antistatic layer with an excellent transparency, the thickness is preferably 1 μm or less, more preferably 0.01 to 0.50 μm, further preferably 0.05 to 0.30 μm and particularly preferably 0.07 to 0.25 μm.

The antistatic layer preferably has a haze of 5% or less, more preferably 3% or less and particularly preferably 1% or less.

The antistatic layer of the invention is provided between the transparent substrate and the hard coat film (hereinafter represented as a hard coat layer), and improves the adhesion among the transparent substrate, the antistatic layer and the hard coat layer.

(Method for Forming Antistatic Layer)

In forming the antistatic layer, the conductive material is preferably employed in a state of a dispersion. In dispersing the conductive material, it is preferably dispersed in a dispersion medium in the presence of a dispersant.

A dispersion with a dispersant enables an extremely fine dispersion of the conductive material, thereby enabling preparation of a transparent antistatic layer.

In the invention, as the dispersant for the conductive material, an anionic dispersant, a cationic dispersant, a nonionic dispersant, or an amphoteric dispersant can be employed advantageously, preferably an anionic dispersant or a nonionic dispersant.

For dispersing the conductive material to be employed in the invention, there is particularly preferred an anionic dispersant having an anionic group. The anionic group can be a group having an acidic proton such as a carboxyl group, a sulfonic acid (sulfo) group, a phosphoric acid (phosphono) group, or a sulfonamide group or a salt thereof, preferably a carboxyl group, a sulfonic acid group, a phosphoric acid group or a salt thereof, and particularly preferably a carboxyl group or a phosphoric acid group. The anionic group may be present by at least one unit per a dispersant molecule, but may be present in plural units per a dispersant molecule in order to improve the dispersibility of the conductive material. It is preferably present in 2 units or more per molecule in average, more preferably 5 units or more, and particularly preferably 10 units or more. Also the anionic groups contained in a dispersant molecule may be of plural kinds.

Examples of the commercially available dispersant include Phosphanol (such as PE-510, PE-610, LB-400, EC-6103, and RE-410; trade names of Toho Chemical Industries Co.), Disperbyk (such as -110, -111, -116, -140, -161, -162, -163, -164, -170 and -171; trade names of Byk Chemie Japan Ltd.), and Solspers (such as -24000; trade name of ICI Japan Ltd.).

The dispersant preferably contains further a crosslinkable or a polymerizable functional group. The crosslinkable or polymerizable functional group can be an ethylenic unsaturated group capable of a crosslinking reaction or a polymerization reaction by radical species (such as a (meth)acryloyl group, an allyl group, a styryl group, or a vinyloxy group), a cationic polymerizable group (such as an epoxy group, an oxatanyl group or a vinyloxy group), a condensation polymerizable group (such as a hydrolysable silyl group or an N-methylol group), an aziridine group, or an isocyanate group. The dispersant having the crosslinkable or polymerizable functional group maintains the dispersion state of the conductive material in the formation of the antistatic layer, and a crosslinking or polymerizing reaction of the dispersant provides an excellent film forming ability thereby improving the physical strength of the antistatic layer.

The dispersant to be employed in dispersing the conductive material for use in the antistatic layer of the invention is preferably a dispersant having an anionic group and a crosslinkable or polymerizable functional group, in which such crosslinkable or polymerizable functional group is contained in a side chain.

A mass-averaged molecular weight (Mw) of the dispersant is not particularly restricted but is preferably 1,000 or larger. The mass-averaged molecular weight (Mw) is within a range of 2,000 to 1,000,000, preferably 5,000 to 200,000 and particularly preferably 10,000 to 100,000.

The dispersant is preferably used in an amount of 1-50 mass % with respect to the conductive material, more preferably 5-30 mass % and most preferably 5-20 mass %. Also the dispersant may be employed in a combination of two or more kinds.

The conductive material is preferably dispersed in a dispersion medium in the presence of a dispersant.

The dispersion medium is preferably a liquid having a boiling point of 50-170° C. Examples of the dispersion medium include water, an alcohol solvent (such as methanol, ethanol, isopropanol, butanol, or benzyl alcohol), a ketone solvent (such as acetone, methyl ethyl ketone, methyl isobutyl ketone, or cyclohexanone), an ester solvent (such as methyl acetate, ethyl acetate, propyl acetate, butyl acetate, methyl formate, ethyl formate, propyl formate, or butyl formate), an aliphatic hydrocarbon solvent (such as hexane or cyclohexanone), a halogenated hydrocarbon solvent (such as dichloromethane, chloroform or carbon tetrachloride), an aromatic hydrocarbon solvent (such as benzene, toluene or xylene), an amide solvent (such as dimethylformamide, dimethylacetamide, or N-methylpyrrolidone), an ether solvent (such as diethyl ether, dioxane or tetrahydrofuran), and an ether alcohol solvent (such as 1-methoxy-2-propanol).

In particular, there is preferred a dispersion medium capable of dissolving the cellulose acylate contained in the antistatic layer. A preferred dispersion medium can be a ketone solvent (such as methyl ethyl ketone, or cyclohexanone), an ester solvent (such as methyl acetate), or a halogenated hydrocarbon solvent (such as dichloromethane).

The conductive material is preferably dispersed with a dispersing apparatus, of which examples include a sand grinder mill (such as a beads mill with pins), a Dyno mill, a high-speed impeller mill, a pebble mill, a roller mill, an attriter and a colloid mill. A dispersing apparatus with a dispersing medium, such as a sand grinder mill or a Dyno mill, is particularly preferable. Also a two-step dispersion may be executed in combination with a pre-dispersion process. A dispersing apparatus employed in the pre-dispersion process can be a ball mill, a three-roll mill, a kneader and an extruder.

The conductive material is preferably dispersed finely in the dispersion medium, preferably with a mass-averaged particle size of 1-700 nm, more preferably 10-500 nm, further preferably 20-300 nm and particularly preferably 30-250 nm.

A fine dispersion of the conductive material to 700 nm or less allows to prepare an antistatic layer excellent in the antistatic property, without deteriorating the transparency.

The antistatic layer of the invention contains the aforementioned cellulose acylate in addition to the conductive material. The cellulose acylate functions as a binder for the conductive material, and also improves the adhesion between the transparent substrate (cellulose acylate film) and the hard coat film.

The cellulose acylate can be an alkylcarbonate ester, an alkenylcarboxylate ester, an aromatic carboxylate ester or an aromatic substituted alkylcarboxylate ester of cellulose as described above, and is more particularly cellulose acetate, cellulose acetate propionate (CAP), cellulose acetate butyrate (CAB), cellulose acetate stearate, or cellulose acetate benzoate.

Among the cellulose acylates, particularly preferable is cellulose acetate, with a substitution degree preferably of 2.0-3.0, more preferably 2.2-3.0 and particularly preferably 2.4-2.95. There is preferred so-called cellulose triacetate (TAC) or cellulose diacetate (DAC).

A content of the conductive material employed in the antistatic layer is preferably 20-90 mass % with respect to all the solids in the antistatic layer, more preferably 30-80 mass %, further preferably 40-70 mass %, particularly preferably 45-60 mass % and most preferably 45-60 mass %.

Also a content of the cellulose acylate employed in the antistatic layer is preferably 10-80 mass % with respect to all the solids in the antistatic layer, more preferably 20-70 mass %, further preferably 30-60 mass %, particularly preferably 35-55 mass % and most preferably 40-55 mass %. Also the cellulose acylate is preferably a principal component of the antistatic layer, other than the conductive material. The principal component means a component of a highest content among the components other than the conductive material.

In the antistatic layer of the invention, it is preferable, for the purpose of further improving the strength of the antistatic layer, to add a binder containing a crosslinkable or polymerizable functional group. The binder having a crosslinkable or polymerizable functional group can be a binder having an ethylenic unsaturated group capable of a crosslinking reaction or a polymerization reaction by radical species (such as a (meth)acryloyl group, an allyl group, a styryl group, or a vinyloxy group), a cationic polymerizable group (such as an epoxy group, an oxatanyl group or a vinyloxy group), a condensation polymerizable group (such as a hydrolysable silyl group or an N-methylol group), an aziridine group, or an isocyanate group. There is preferred a binder having a (meth)acryloyl group, an allyl group, an epoxy group, or an isocyanate group, and particularly preferably a binder having a (meth)acryloyl group or an isocyanate group.

The antistatic layer of the invention is particularly preferably prepared by adding a binder having a crosslinkable or polymerizable functional group, a polymerization initiator, a reaction promoter and the like to a liquid containing the aforementioned conductive material and the aforementioned cellulose acylate thereby forming a coating liquid for forming the antistatic layer, coating the coating liquid for forming the antistatic layer on a transparent substrate and curing the binder having the crosslinkable or polymerizable functional group by a crosslinking or polymerizing reaction.

The binder having the crosslinkable or polymerizable functional group is preferably a compound curable with an ionizing radiation, such as a polyfunctional monomer or a polyfunctional oligomer curable with an ionizing radiation to be explained later.

In the aforementioned method of preparation, the binder of the antistatic layer preferably contains a dispersant, a cellulose acylate and a cured substance of a binder having a crosslinkable or polymerizable functional group.

Also the binder of the antistatic layer is preferably formed, simultaneously with or after the coating of the layer, by curing, by a crosslinking or polymerizing reaction, the dispersant, the cellulose acylate and the binder having the crosslinkable or polymerizable functional group.

In the binder of the antistatic layer thus coated, the dispersant having the crosslinkable or polymerizable functional group, the cellulose acylate and the binder having the crosslinkable or polymerizable functional group execute a crosslinking or polymerizing reaction whereby the anionic group of the dispersant is incorporated in the binder and the anionic group has a function of maintaining the dispersion state of the conductive material, while the crosslinkable or polymerizable structure provides the binder with a film forming ability, thereby favorably improving the physical strength and the chemical resistance of the antistatic layer containing the conductive material.

The functional group of the binder having the crosslinkable or polymerizable functional group is preferably capable of crosslinking or polymerization by a light, heat, an electron beam or a radiation, and more preferably a functional group capable of crosslinking or polymerization by a light or heat.

A photopolymerizable functional group can be an unsaturated polymerizable functional group such as a (meth)acryloyl group, a vinyl group, a styryl group or an allyl group, preferably a (meth)acryloyl group.

Specific examples of a photopolymerizable polyfunctional monomer having a photopolymerizable functional group include a (meth)acrylate diester of an alkylene glycol such as neopentyl glycol acrylate, 1,6-hexanediol (meth)acrylate, propylene glycol di(meth)acrylate, a (meth)acrylate diester of a polyoxyalkylene glycol such as such as triethylene glycol di(meth)acrylate, dipropylene glycol di(meth)acrylate, polyethylene glycol di(meth)acrylate or polypropylene glycol di(meth)acrylate, a (meth)acrylate diester of a polyhydric alcohol such as pentaerythritol di(meth)acrylate, and a (meth)acrylate diester of an ethylene oxide or propylene oxide addition product such as 2,2-bis{4-(acryloxy-diethoxy)phenyl}propane, or 2-2-bis{4-(acryloxy-polypropoxy)phenyl}propane.

There can also be advantageously employed, as the photopolymerizable polyfunctional monomer, an epoxy (meth)acrylate, an urethane (meth)acrylate, or a polyester (meth)acrylate.

Among these, an ester of a polyhydric alcohol and (meth)acrylic acid is preferred, and a polyfunctional monomer having three or more (meth)acryloyl groups in a molecule is more preferred. Specific examples include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, and tripentaerythritol hexatriacrylate.

The polyfunctional monomer may be employed in a combination of two or more kinds.

In a polymerization reaction of the photopolymerizable polyfunctional monomer, a photopolymerization initiator is preferably employed. The photopolymerization initiator is preferably a photoradical polymerization initiator or a photocationic polymerization initiator, and particularly preferably a photoradical polymerization initiator.

The photoradical polymerization initiator can be, for example, an acetophenone, a benzophenone, Michler's benzoyl benzoate, an α-amyloxime ester, tetramethylthiuram monosulfide or a thioxanthone.

Examples of the commercially available photoradical polymerization initiator include Kayacure manufactured by Nippon Kayaku Co. (DETX-S, BP-100, BDMK, CTX, BMS, 2-EAQ, ABQ, CPTX, EPD, ITX, QTX, BTC, MCA etc.), Irgacure manufactured by Ciba Specialty Chemicals Inc. (651, 184, 500, 907, 369, 1173, 2959, 4265, 4263 etc.), and Esacure manufactured by Sartomer Co. (such KIP100F, KBI, EB3, BP, X33, KT046, KT37, KIP150, TZT etc.).

In particular, a photoradical polymerization initiator of photocleavable type is preferable. The photoradical polymerization initiator of photocleavable type is described in Kazuhiro Takahashi, “Latest UV curing technology” (Gijutsu Joho Kyokai, p. 159, 1991).

The commercially available photoradical polymerization initiator of photocleavable type is, for example, Irgacure manufactured by Ciba Specialty Chemicals Inc. (651, 184, or 907).

The photopolymerization initiator is preferably employed within a range of 0.1 to 15 parts by mass with respect to 100 parts by mass of the polyfunctional monomer, more preferably 1 to 10 parts by mass.

A photosensitizer may be employed in addition to the photopolymerization initiator. Examples of the photosensitizer include n-butylamine, triethylamine, tri-n-butylphosphine, Michler's ketone and thioxanthone.

Examples of the commercially available photosensitizer include Kayacure manufactured by Nippon Kayaku Co. (DMBI, or EPA).

The photopolymerization is preferably executed by an ultraviolet irradiation after the antistatic layer is coated and dried.

The ultraviolet irradiation can be executed with an ultraviolet light from a light source such as an ultra high-pressure mercury lamp, a low-pressure mercury lamp, a carbon arc, a xenon arc, or a metal halide lamp.

Also as the binder having the crosslinkable or polymerizable functional group, there can also be advantageously employed a heat curable compound, such as a monomer or an oligomer having an epoxy group, an aziridine group or an isocyanate group, particularly a monomer or an oligomer having an isocyanate group.

The binder having isocyanate group is a polyisocyanate compound having two or more isocyanate groups, for example an isocyanate such as tolylene diisocyanate, hexamethylene diisocyanate, xylylene diisocyanate, naphthylene-1,5-diisocyanate, o-toluidine diisocyanate, isophorone diisocyanate, triphenylmethane diisocyanate, a reaction product of such isocyanate and a polyalcohol (such as a reaction product of 3 moles of tolylene diisocyanate and 1 mole of trimethylolpropane), or a polyisocyanate formed by a condensation of such isocyanate.

In the binder having the isocyanate group, a content of the isocyanate group is preferably 20-40 mass %, more preferably 25-35 mass %.

Examples of the commercially available product include Millionate (MT, MR-100, MR-200, MR-300, MR-400 etc.; trade names of Nippon Polyurethane Co.), Coronate (L etc.; trade name of Nippon Polyurethane Co.), and Sumijule (44V10; trade name of Sumitomo Bayer Urethane Co.). Also in case of using the binder having the isocyanate group, it is also preferable to use a crosslinking promoter such as a tertiary amine, a metal salt, or a DBU (1,8-diaza-bicyclo[5,4,0]undecene-7) compound.

In the preparation of the antistatic layer, each of the conductive material, the dispersant, the cellulose acylate, and the binder having the crosslinkable or polymerizable functional group may be employed in plural kinds.

The antistatic layer is preferably prepared by coating a coating liquid for forming the antistatic layer on a transparent substrate, or, if necessary, by executing a crosslinking or polymerizing reaction simultaneous with or after the coating operation.

The conductive material is preferably dispersed finely in the antistatic layer, preferably with a mass-averaged particle size of 1-700 nm, more preferably 10-500 nm, further preferably 20-300 nm and particularly preferably 30-250 nm.

A fine dispersion of the conductive material to 700 nm or less allows to prepare an antistatic layer excellent in the antistatic property, without deteriorating the transparency.

Examples of a preferable coating solvent for the antistatic layer include a ketone solvent (such as acetone, methyl ethyl ketone, methyl isobutyl ketone, or cyclohexanone), an ester solvent (such as methyl acetate, ethyl acetate, propyl acetate, butyl acetate, methyl formate, ethyl formate, propyl formate, or butyl formate), an aliphatic hydrocarbon solvent (such as hexane or cyclohexanone), a halogenated hydrocarbon solvent (such as dichloromethane, chloroform or carbon tetrachloride), an aromatic hydrocarbon solvent (such as benzene, toluene or xylene), an amide solvent (such as dimethylformamide, dimethylacetamide, or N-methylpyrrolidone), an ether solvent (such as diethyl ether, dioxane or tetrahydrofuran), and an ether alcohol solvent (such as 1-methoxy-2-propanol). In particular, there is preferred a solving capable of dissolving the cellulose acylate contained in the antistatic layer and/or the transparent substrate. A preferred coating solvent can be a ketone solvent (such as methyl ethyl ketone, or cyclohexanone), an ester solvent (such as methyl acetate), or a halogenated hydrocarbon solvent (such as dichloromethane). A particularly preferable coating solvent is methyl ethyl ketone, cyclohexanone, or dichloromethane.

The coating solvent may contain another solvent, such as water, an aliphatic hydrocarbon (such as hexane or cyclohexane), an amide (such as dimethylformamide, dimethylacetamide, or N-methylpyrrolidone), an ether (such as diethyl ether, dioxane, or tetrahydrofurane), or an ether alcohol (such as 1-methoxy-2-propanol).

In the coating solvent, a total amount of the ketone solvent, ester solvent and halogenated hydrocarbon solvent preferably represents 10 mass % or more of the total solvent. It preferably represents 30 mass % or more and more preferably 50 mass % or more.

The antistatic layer is preferably formed, particularly in case the antistatic layer contains a compound curable with an ionizing radiation and is prepared by a crosslinking or polymerizing reaction of the ionizing radiation-curable compound, is executed in an atmosphere with an oxygen concentration of 10 vol. % or less.

Formation of the antistatic layer in an atmosphere with an oxygen concentration of 10 vol. % or less allows to improve the physical strength (such as scratch resistance) and the chemical resistance of the antistatic layer.

The antistatic layer is preferably formed by a crosslinking or polymerizing reaction of the ionizing radiation-curable compound in an atmosphere with an oxygen concentration of 4 vol. % or less, further preferably in an atmosphere with an oxygen concentration of 2 vol. % or less, particularly preferably in an atmosphere with an oxygen concentration of 1 vol. % or less, and most preferably in an atmosphere with an oxygen concentration of 0.5 vol. % or less.

For obtaining an oxygen concentration of 10 vol. % or less, there is preferred a replacement of the air (with a nitrogen concentration of about 79 vol. % and an oxygen concentration of about 21 vol. %) with another gas, and particularly preferably a replacement with nitrogen (nitrogen purging).

The antistatic layer may include, in addition to the aforementioned components (conductive material, polymerization initiator, photosensitizer, binder and the like), a resin, a surfactant, a coupling agent, a viscosifier, a coloration preventing agent, a colorant (pigment or dye), a defoaming agent, a leveling agent, a flame retardant, an ultraviolet absorber, an infrared absorber, an adhesion promoter, a polymerization inhibitor, an antioxidant, a surface modifying agent and the like.

The antistatic layer is constructed between the transparent substrate and the hard coat layer, preferably constructed as a layer adjacent to the transparent substrate, and particularly preferably a layer adjacent to the transparent substrate and the hard coat layer.

(Transparent Substrate)

The transparent substrate is formed by a cellulose acylate (for example an alkylcarboxylate ester, an alkenylcarboxylate ester, an aromatic carboxylate ester or an aromatic substituted alkylcarboxylate ester of cellulose as described above, such as cellulose acetate, cellulose acetate propionate (CAP), cellulose acetate butyrate (CAB), cellulose acetate stearate, or cellulose acetate benzoate).

Among these, cellulose acetate is particularly preferable, with a substitution degree preferably of 2.6-3.0, and cellulose triacetate (TAC) is most preferable.

The cellulose acylate film is preferably formed by casting a cellulose acylate dope, prepared by dissolving cellulose acylate in a solvent, by a single-layer casting method or a plural-layer co-casting method.

Particularly from the standpoint of environmental protection, there is preferred a cellulose acylate film formed with a cellulose acylate dope, prepared by dissolving the cellulose acylate in a solvent substantially free from dichloromethane, by a low-temperature dissolving method or a high-temperature dissolving method.

A cellulose acylate film preferably employable in the invention is described in the Japan Institute of Invention and Innovation, Laid-open Technical Report (2001-1745).

A thickness of the transparent substrate is not particularly restricted, and is generally in a range of 1-300 μm, preferably 30-150 nm, particularly preferably 40-120 μm and most preferably 40-100 μm.

The transparent substrate preferably has an optical transmittance of 80% or higher, and more preferably 86% or higher.

The transparent substrate desirably has a low haze, preferably 2.0% or less and more preferably 1.0% or less.

The transparent substrate preferably has a refractive index of 1.40-1.70.

In the transparent substrate, an infrared absorber or an ultraviolet absorber may be added. An amount of the infrared absorber is preferably 0.01-20 mass % of the transparent substrate, and more preferably 0.05-10 mass %.

Also the transparent substrate may contain particles of an inert inorganic compound as a lubricant. Examples of the inorganic compound include SiO₂, TiO₂, BaSO₄, CaCO₃, talc and caolin.

The cellulose acylate film may be subjected to a surface treatment. Examples of the surface treatment include a chemical treatment, a mechanical treatment, a corona discharge treatment, a flame treatment, an ultraviolet irradiation treatment, a high-frequency treatment, a glow discharge treatment, an active plasma treatment, a laser treatment, a mixed acid treatment and an ozone treatment. A glow discharge treatment, an ultraviolet irradiation treatment, a corona discharge treatment or a flame treatment is preferable, and a glow discharge treatment or a corona discharge treatment is particularly preferable.

(Hard Coat Film)

In order to provide a physical strength with the optical film, a hard coat film (hereinafter represented as hard coat layer) is preferably provided on the antistatic layer.

The hard coat layer is normally formed with a compound curable with an ionizing radiation or a reactive organic silicon compound, and is preferably formed by a crosslinking or polymerizing reaction of an ionizing radiation-curable compound. For example it can be formed by coating a coating liquid, containing a polyfunctional monomer or a polyfunctional oligomer curable with an ionizing radiation, on the transparent substrate, and executing a crosslinking or polymerizing reaction of the polyfunctional monomer or the polyfunctional oligomer.

The polyfunctional monomer or the polyfunctional oligomer curable with an ionizing radiation preferably has a functional group capable of polymerization with a light, an electron beam or a radiation, particularly preferably a functional group capable of photopolymerization.

The photopolymerizable functional group can be an unsaturated polymerizable group such as a (meth)acryloyl group, a vinyl group, a styryl group, or an allyl group, preferably a (meth)acryloyl group.

A preferred example of the polyfunctional oligomer, constituting the hard coat layer, is a polyester dendrimer (A) containing an ethylenic unsaturated group, for the purpose of a curl reduction and an improvement in the flexibility of the coated film. The polyester dendrimer (A) containing an ethylenic unsaturated group can be obtained by reacting a polyesterpolyol dendrimer compound (a) containing 6 or more hydroxyl groups in a molecule with a monocarboxylic acid (b) containing an ethylenic unsaturated group.

The polyester polyol dendrimer compound containing 6 or more hydroxyl groups in a molecule can be any polyesterpolyol having a highly branched molecular structure by ester bonds in which most terminal groups are hydroxyl groups, but is preferably a compound represented by a following general formula (1), more specifically such as Boltorn H20, Boltorn H30, Boltorn H40, Boltorn H2003, Boltorn H2004, or Boltorn P1000 (all manufactured by Perstorp AB). 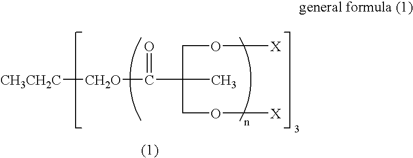
wherein X represents a dimethylolpropionic acid residue or a hydrogen atom; and n represents an integer of 1-10.

The monocarboxylic acid containing an ethylenic unsaturated group can be, for example, an acrylic acid, a crotonic acid, α-cyanocinnamic acid, cinnamic acid, or a reaction product of a saturated or unsaturated dibasic acid and a monoglycidyl compound containing an unsaturated group.

The acrylic acid can be, for example, acrylic acid, an acrylic acid dimer, methacrylic acid, β-styrylacrylic acid, β-furfurylacrylic acid, a half ester which is an equimolar reaction product of a saturated or unsaturated dibasic acid anhydride and a (meth)acrylate derivative having a hydroxyl group in a molecule, or a half ester which is an equimolar reaction product of a saturated or unsaturated dibasic acid and a monoglycidyl (meth)acrylate derivative, and preferably acrylic acid.

The half ester which is an equimolar reaction product of a saturated or unsaturated dibasic acid anhydride and a (meth)acrylate derivative having a hydroxyl group in a molecule can be, for example, a half ester which is a reaction product of 2-hydroxyethyl (meth)acrylate, 2-hydroxypropyl (meth)acrylate, or 1,4-butanediol (meth)acrylate, and a dibasic acid anhydride (such as succinic anhydride, maleic anhydride, phthalic anhydride, tetrahydrophthalic anhydride, or hexahydrophthalic anhydride).

The half ester which is an equimolar reaction product of a saturated or unsaturated dibasic acid and a monoglycidyl (meth)acrylate derivative can be, for example, a product obtained by reacting the aforementioned dibasic acid anhydride with a reaction product of glycidyl methacrylate and (meth)acrylic acid.

The reaction product of a saturated or unsaturated dibasic acid and a monoglycidyl compound containing an unsaturated group can be, for example, a product obtained by reacting the aforementioned dibasic acid anhydride with a reaction product of a phenyl diglycidyl ether compound, a bisphenol-type epoxy compound, a hydrogenated bisphenol-type epoxy compound, an alicyclic diglycidyl ether compound, an aliphatic diglycidyl ether compound, a polysulfide-type diglycidyl ether compound, a biphenol-type epoxy compound, a bixylenol-type epoxy compound, an epoxy compound having a halogenated bisphenol skeleton or an epoxy compound having a halogenated biphenol skeleton, with (meth)acrylic acid.

Such compound may be employed singly or in a mixture of two or more kinds.

The ethylenic unsaturated group-containing polyester dendrimer (A) contained in the hard coat layer is obtained by reacting the polyesterpolyol dendrimer compound (a) with the ethylenic unsaturated group-containing monocarboxylic acid (b), preferably by a dehydration condensation of (a) and (b) in the presence of an acid catalyst such as sulfuric acid, methanesulfonic acid or p-toluenesulfonic acid.

A content of the ethylenic unsaturated group-containing polyester dendrimer (A) in the hard coat layer after curing is preferably 10-80 mass % of the solids of the hard coat layer, for reducing curling and cracks, more preferably 20-70 mass % and further preferably 30-60 mass %.

Examples of the photopolymerizable polyfunctional monomer having a photopolymerizable functional group can be same as those described for the antistatic layer, and such monomer is preferably polymerized utilizing a photopolymerization initiator and a photosensitizer. The photopolymerization is preferably executed by an ultraviolet irradiation after the hard coat layer is coated and dried.

The hard coat layer is preferably formed by coating a coating liquid for forming the hard coat layer. The hard coat layer is constructed on the antistatic layer for the purpose of providing the optical film with a high physical strength, preferably constructed as an adjacent layer on the antistatic layer.

A preferred coating solvent can be a ketone solvent, an ester solvent, or an aromatic hydrocarbon solvent exemplified for the antistatic layer. In particular, a ketone solvent further improves the adhesion of the antistatic layer and the hard coat layer.

A particularly preferable coating solvent is methyl ethyl ketone, methyl isobutyl ketone or cyclohexanone.

The coating solvent may contain another solvents other than the solvents exemplified for the antistatic layer.

In the coating solvent, a content of the ketone solvent preferably represents 10 mass % or more of the total solvent. It preferably represents 30 mass % or more and more preferably 60 mass % or more.

In case the hard coat layer is prepared by a crosslinking or polymerizing reaction of a compound curable with an ionizing radiation, the crosslinking or polymerizing reaction of the ionizing radiation-curable compound is preferably executed in an atmosphere with an oxygen concentration of 10 vol. % or less. Formation of the hard coat layer in an atmosphere with an oxygen concentration of 10 vol. % or less allows to improve the physical strength (such as scratch resistance) and the chemical resistance.

It is preferably formed by a crosslinking or polymerizing reaction of the ionizing radiation-curable compound in an atmosphere with an oxygen concentration of 4 vol. % or less, further preferably in an atmosphere with an oxygen concentration of 2 vol. % or less, particularly preferably in an atmosphere with an oxygen concentration of 1 vol. % or less, and most preferably in an atmosphere with an oxygen concentration of 0.5 vol. % or less.

For obtaining an oxygen concentration of 10 vol. % or less, there is preferred a replacement of the air (with a nitrogen concentration of about 79 vol. % and an oxygen concentration of about 21 vol. %) with another gas, and particularly preferably a replacement with nitrogen (nitrogen purging).

It is also preferable that the hard coat layer includes, in addition to the aforementioned ionizing radiation-curable compound, the cellulose acylate described for the antistatic layer, as a binder.

A thickness of the hard coat layer can be selected suitably according to the application. The hard coat layer preferably has a thickness of 1-10 μm, more preferably 2-7 μm and particularly preferably 3-5 μm.

The hard coat layer preferably has a strength of H or higher in a pencil hardness test according to JIS K5400, more preferably 2H or higher and most preferably 3H or higher. Also in a Taber test according to JIS K5400, an abrasion amount of a test piece is preferably as small as possible between before and after the test.

In the hard coat layer, there can be added a resin, a dispersant, a surfactant, an antistatic agent, a silane coupling agent, a viscosifier, a coloration preventing agent, a colorant (pigment or dye), a defoaming agent, a leveling agent, a flame retardant, an ultraviolet absorber, an adhesion promoter, a polymerization inhibitor, an antioxidant, or a surface modifying agent. It is also possible, for the purposes of increasing the hardness of the hard coat layer, suppressing the shrinkage in curing and controlling the refractive index, to add inorganic fine particles, to be explained later, of an average primary particle size of 1-200 nm. It is also possible, for the purpose of further reducing the surface resistivity of the hard coat layer, to add conductive particles, to be explained later, of an average particle size of 0.2-10 μm. It is furthermore possible, for providing an antiglare function or a light diffusing function, to add particles, to be explained later, of an average particle size of 0.2-10 μm.

(Conductive Particles of Average Particle Size of 0.2-10 μM)

The hard coat layer is normally formed with a compound curable with an ionizing radiation, or a reactive organic silicon compound. In case the hard coat layer is not so thick, even if the hard coat layer alone does not have a conductive property, the electroconductivity of the antistatic layer is transmitted to the surface of the hard coat layer, whereby the surface resistivity is lowered at the side having the hard coat layer, thereby exhibiting an antistatic effect. Also since an optical interference layer (high refractive index layer, medium refractive index layer, low refractive index layer) to be explained later also has a small thickness, such layer, when laminated on the hard coat layer, shows a lowered surface resistivity, thereby exhibiting an antistatic effect.

However, in case the hard coat layer has a large thickness, the electroconductivity of the antistatic layer is not easily transmitted to the surface of the hard coat layer, whereby the antistatic property at the side having the hard coat layer becomes extremely weak. In order to exhibit an antistatic property more effectively on the surface on the side having the hard coat layer, it is preferable to add conductive particles of an average particle size of 0.2-10 μm to the hard coat layer. The conductive particles of an average particle size of 0.2-10 μm perform a function of transmitting the electroconductivity of the antistatic layer to the surface of the hard coat layer, thereby reducing the surface resistivity thereof and exhibiting a satisfactory antistatic effect.

The aforementioned conductive particles to be added to the hard coat layer can be carbon black, antimony-doped tin oxide (ATO), tin-doped indium oxide (ITO), electron conductive metal particles (such as Au, Ag, Cu or Ni), or particles of an organic compound (such as resin particles) or an inorganic compound such as a silicone resin, a melamine resin, an acrylic resin, an epoxy resin, a polyamide resin, a polyurethane resin, a benzoguanamine resin, a polymethyl methacrylate resin, a polystyrene resin, a polyvinylidene fluoride resin, silicon dioxide, titanium dioxide, zirconium oxide, aluminum oxide, zinc oxide, calcium carbonate, or barium sulfate, of which surface is covered with a conductive compound (such as a metal such as Au and/or Ni or a conductive metal oxide).

Such conductive particles preferably have an average particle size of 30% or larger of the thickness of the hard coat layer, more preferably 30-110% of the thickness, further preferably 50-100% and particularly preferably 60-90%. The particles have an average particle size preferably of 0.5-7.0 μm, more preferably 1.0-5.0 μm and particularly preferably 2.0-4.0 μm. Also the average particle size of the conductive particles is preferably smaller than the thickness of the hard coat layer.

The particle size distribution of the particles is preferably as narrow as possible. A narrower particle size distribution of the particles allows to effectively exhibit the antistatic effect. A value S, representing the particle size distribution of the particles, is given by a following equation, and is preferably 2.0 or less, more preferably 1.0 or less and particularly preferably 0.7 or less.
S=[D(0.9)−D(0.1)]/D(0.5)
wherein:

D(0.1): a value at 10% of a cumulative volume-converted particle size distribution;

D(0.5): a value at 50% of a cumulative volume-converted particle size distribution; and

D(0.9): a value at 90% of a cumulative volume-converted particle size distribution.

The aforementioned conductive particles may be included in another layer than the hard coat layer. The layer containing the aforementioned conductive particles becomes an anisotropically conductive layer showing different resistivities in a direction of thickness and a direction along the film plane, and in particular the conductivity in the direction of thickness is preferably as high as possible. The layer containing the aforementioned conductive particles preferably has a volumic resistivity in the direction of thickness of 10¹⁰ Ω·cm or less, preferably 10⁸ Ω·cm or less, more preferably 10⁷ Ω·cm or less, and particularly preferably 10⁶ Ω·cm or less.

(Configuration of Optical Film)

In the optical film of the invention, still other layers may be constructed. For example, formation of an optical interference layer (high refractive index layer, medium refractive index layer, low refractive index layer etc. discussed later) allows to obtain an optical film excellent in the antireflective property (antireflective film). Also formation of a layer for providing surface irregularities (such as an antiglare layer) on the surface of the optical film allows to obtain an optical film capable of preventing a reflection of an external light (antiglare film). Also formation of a layer for diffusing the transmitted light (such as a light diffusing layer) by adding, to the optical film, particles of a refractive index different from that of the matrix of the layer, allows to obtain an optical film (light diffusing film) capable of expanding a viewing angle of a liquid crystal display apparatus. In the following, there will be explained additives and configurations employed preferably in the optical film.

(Inorganic Fine Particles with Average Particle Size of 1-200 Nm)

In the optical film, it is preferable to construct a layer containing inorganic fine particles of which primary particles have an average particle size of 1-200 nm, between the transparent substrate and an outermost layer formed on the transparent substrate (hereinafter represented as an outermost layer). The aforementioned average particle size means a mass-averaged particle size. An average particle size of the primary particles within a range of 1 to 200 nm allows to obtain a layer not deteriorating the transparency.

The inorganic fine particles of which primary particles have an average particle size of 1-200 nm are employed for the purposes of increasing the hardness of the layer, suppressing the shrinkage at curing and controlling the refractive index.

The inorganic fine particles can be, in addition to those described for the antistatic layer (metal oxide fine particles, metal fine particles and the like), fine particles of silicon dioxide, magnesium fluoride, aluminum oxide, calcium carbonate, barium sulfate, talc, caolin, calcium sulfate, titanium dioxide, zirconium oxide, zinc oxide, or zinc sulfide.

There is preferred silicon dioxide, titanium dioxide, zirconium oxide, aluminum oxide, tin oxide, ATO, ITO or zinc oxide.

As the inorganic fine particles of an average particle size of 1-200 nm, particles of plural kinds with different average particle sizes may be employed in combination. It is also preferable to utilize particles of plural different materials in combination.

In the inorganic fine particles, the primary particles preferably have an average particle size of 5-200 nm, more preferably 10-150 nm, further preferably 20-100 nm and particularly preferably 20-50 nm.

In the layer, the inorganic fine particles are preferably dispersed as finely as possible, and preferably dispersed with a dispersant. In the layer, the inorganic fine particles preferably have a particle size, in an average particle size, of 5-300 nm, more preferably 10-200 nm, further preferably 20-150 nm, and particularly preferably 20-80 nm. Particularly in case of use in an optical interference layer (high refractive index layer, medium refractive index layer, low refractive index layer etc. to be explained later), the particle size is preferably 200 nm or less.

As to the dispersing method, items that have been explained for the antistatic layer are applicable.

A content of the inorganic fine particles in the layer is preferably 10-90 mass % with respect to the entire mass of the layer, more preferably 15-80 mass % and particularly preferably 15-75 mass %.

In case of preparing a layer of a high refractive index (such as a high refractive index layer or a medium refractive index layer), such layer is preferably prepared by finely dispersing inorganic fine particles of a high refractive index (such as of titanium dioxide, zirconium oxide, aluminum oxide, tin oxide, ATO, ITO, or zinc oxide) in the layer by a method similar to that described for the antistatic layer.

In case of preparing a layer of a low refractive index (such as a low refractive index layer), such layer is preferably prepared by finely dispersing inorganic fine particles of a low refractive index (such as of silicon dioxide, hollow silicon dioxide, magnesium fluoride or calcium fluoride) in the layer.

A layer containing inorganic fine particles of an average particle size of 1-200 nm is preferably a hard coat layer, or an antiglare layer, a light diffusing layer, a high refractive index layer, a medium refractive index layer, or a low refractive index layer to be explained later.

The layer containing inorganic fine particles of an average particle size of 1-200 nm preferably contains a binder of an organic compound. Also, as in the hard coat layer, the binder is preferably a cured substance of a compound having a crosslinkable or polymerizable functional group, and is preferably formed by a crosslinking or polymerizing reaction of a compound curable with an ionizing radiation.

The layer containing inorganic fine particles of an average particle size of 1-200 nm preferably has a haze of 5% or less, more preferably 3% or less, particularly preferably 2% or less and most preferably 1% or less.

The layer containing inorganic fine particles of an average particle size of 1-200 nm preferably has a strength of H or higher in a pencil hardness test according to JIS K5400, more preferably 2H or higher and most preferably 3H or higher. Also in a Taber test according to JIS K5400, an abrasion amount of a test piece is preferably as small as possible between before and after the test.

(Particles with Average Particle Size of 0.2-10 μm)

In the optical film, it is preferable to construct a layer containing particles having an average particle size of 0.2-10 μm (such as an antiglare layer or a light diffusing layer), on the transparent substrate.

The particles having an average particle size of 0.2-10 μm are employed for the purposes of providing the optical film with an antiglare function and/or a light diffusing function of diffusing the transmitted light thereby expanding a viewing angle of a liquid crystal display apparatus.

Such particles can be those of an inorganic compound, those of an organic compound (such as resin particles) or composite particles of inorganic/organic compounds, and preferably particles of a resin or particles of silicon dioxide. The particles preferably have a particle size distribution as narrow as possible. A refractive index of the particles is not particularly restricted, and is preferably 1.35-1.80, more preferably 1.40-1.75, and further preferably 1.40-1.75.

The refractive index of the particles is, in case of an antiglare layer, is preferably approximately same (difference in refractive index being 0.005 or less) as the refractive index of a matrix of the layer (namely refractive index of the layer excluding the particles with an average particle size of 0.2-10 μm), or different by 0.02 or more.

A refractive index approximately same as that of the matrix of the layer improves the contrast when the optical film is mounted on an image display surface. On the other hand, a difference in the refractive index formed between the particles and the matrix of the layer improves the visibility (a glitter failure or a viewing angle property of a liquid crystal display apparatus) when the optical film is mounted on an image display surface.

In case of forming a difference in the refractive index between the particles and the matrix of the layer, such difference is preferably 0.03-0.5, more preferably 0.03-0.4 and particularly preferably 0.05-0.3.

In case of a light diffusing layer, the refractive index of the particles is preferably different from that of the matrix of the layer by 0.02 or more.

In case of forming a difference in the refractive index between the particles and the matrix of the layer, such difference is preferably 0.03-0.5, more preferably 0.03-0.4 and particularly preferably 0.05-0.3.

The layer containing particles having an average particle size of 0.2-10 μm may be constructed on the transparent substrate, and is preferably constructed at a side having the antistatic layer of the invention. Such layer is preferably the hard coat layer, the antistatic layer, the low refractive index layer, the high refractive index layer, or the medium refractive index layer mentioned above, and more preferably the hard coat layer, the antistatic layer or the high refractive index layer, and most preferably the hard coat layer.

In the layer containing particles having an average particle size of 0.2-10 μm, a description in JP-A No. 2003-4903 is particularly preferably applicable.

(Organosilane Compound)

In the following, there will be described an organosilane compound advantageously employable in the layers of the optical film of the invention.

In order to improve a physical strength (such as scratch resistance) of a film or an adhesive property of a layer adjacent to films, an organosilane compound and/or a derivative thereof is preferably added in either of the layers on the transparent substrate.

As the organosilane compound and/or a derivative thereof, a compound represented by the aforementioned general formula (a) or (b) and/or a derivative thereof can be employed. There is preferred an organosilane compound having a hydroxyl group, a mercapto group, a carboxyl group, an epoxy group, an alkyl group, an alkoxysilyl group, an acyloxy group, or an acylamino group, and particularly preferred is an organosilane compound having an epoxy group, a polymerizable acyloxy group (such as (meth)acryloyl), or a polymerizable acylamino group (such as acrylamino, or methacrylamino).

(Other Additives)

Also in each layer of the optical film, there can be added for example a resin, a dispersant, a surfactant, an antistatic agent, a silane coupling agent, a viscosifier, a coloration preventing agent, a colorant (pigment or dye), a defoaming agent, a leveling agent, a flame retardant, an ultraviolet absorber, an adhesion promoter, a polymerization inhibitor, an antioxidant, or a surface modifying agent.

(Low Refractive Index Layer)

A low refractive index layer can be constructed for providing the optical film with an antireflective property. In the low refractive index layer, a binder is employed for dispersing and fixing the fine particles of the invention. The binder can be that described for the hard coat layer, but is preferably a fluorine-containing polymer having a low refractive index in the binder itself or a fluorine-containing sol-gel material. As the fluorine-containing polymer or the fluorine-containing sol-gel material, there is preferred a material crosslinkable by heat or by an ionizing radiation and having a dynamic friction coefficient of 0.03-0.30 and a contact angle to water of 85-120°.

The low refractive index layer has a refractive index preferably of 1.20-1.46, more preferably 1.25-1.46, and particularly preferably 1.30-1.46.

The low refractive index layer has a thickness preferably of 50-200 nm, and more preferably 70-100 nm. The low refractive index layer has a haze preferably of 3% or less, more preferably 2% or less and most preferably 1% or less. The low refractive index layer preferably has a strength of H or higher in a pencil hardness test under a load of 500 g, more preferably 2H or higher and most preferably 3H or higher.

Also for improving the antistain property of the optical film, the surface thereof preferably has a contact angle to water of 90° or higher, more preferably 95° or higher and particularly preferably 100° or higher.

In the following, a copolymer preferably employed in the low refractive index layer of the invention will be explained.

The fluorine-containing monomer can be a fluoroolefin (such as fluoroethylene, vinylidene fluoride, tetrafluoroethylene, or hexafluoropropylene), a partially or completely fluorinated alkyl ester derivative of (meth)acrylic acid (such as Viscote 6FM (manufactured by Osaka Organic Chemical Industry Ltd.) or R-2020 (manufactured by Daikin Co.)) or a completely or partially fluorinated vinyl ether, and preferably a perfluoroolefin, and, particularly preferably hexafluoropropylene in consideration of refractive index, solubility, transparency and availability. An increase in the composition ratio of such fluorine-containing vinyl monomer can lower the refractive index, but reduces the film strength. In the present invention, the fluorine-containing vinyl monomer is preferably introduced in such a manner that the copolymer has a fluorine content of 20-60 mass %, more preferably 25-55 mass %, and particularly preferably 30-50 mass %.

As a constituent for providing a crosslinking property, following units represented by following (A), (B) and (C) can be principally considered:

(A) a constituent unit obtained by a polymerization of a monomer having a self-crosslinkable functional group within a molecule, such as glycidyl (meth)acrylate, or glycidyl vinyl ether;

(B) a constituent unit obtained by a polymerization of a monomer having a carboxyl group, a hydroxyl group, an amino group or a sulfo group (such as (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid);

(C) a constituent unit obtained by reacting a compound having a group reactive with the functional group of (A) or (B) and another crosslinkable functional group within a molecule, with the constituent unit (A) or (B) (such as a constituent unit synthesizable for example by reacting acrylic chloride with a hydroxyl group).

In the constituent unit (C), particularly in the invention, the crosslinkable functional group is preferably a photopolymerizable group. The photopolymerizable group can be, for example, a (meth)acryloyl group, an alkenyl group, a cinnamoyl group, a cinnamylideneacetyl group, a benzalacetophenone group, a styrylpyridine group, an α-phenylmaleimide group, a phenylazide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group, or an azadioxabicyclo group. These may be employed singly or in a combination of two or more kinds. Among these, a (meth)acryloyl group or a cinnamoyl group is preferable, and a (meth)acryloyl group is particularly preferable.

A copolymer containing a photopolymerizable group can be prepared by following methods, but these are not restrictive:

(1) A method of forming an ester by reacting a crosslinkable functional group-containing copolymer including a hydroxyl group with (meth)acrylic chloride;

(2) A method of forming an urethane by reacting a crosslinkable functional group-containing copolymer including a hydroxyl group with a (meth)acrylate ester having an isocyanate group;

(3) A method of forming an ester by reacting a crosslinkable functional group-containing copolymer including an epoxy group with (meth)acrylic acid; and

(4) A method of forming an ester by reacting a crosslinkable functional group-containing copolymer including a carboxyl group with a (meth)acrylate ester having an epoxy group.

An amount of introduction of the photopolymerizable group can be regulated arbitrarily, and it is also preferable to leave a carboxyl group or a hydroxyl group by a certain amount in consideration of a stability of the coated film surface, a reduction of the surface defect in the presence of inorganic fine particles and an improvement in the film strength.

In the copolymer useful in the invention, in addition to the repeating unit derived from the aforementioned fluorine-containing vinyl monomer and the repeating unit having a (meth)acryloyl group in the side chain, another vinyl monomer may be suitably copolymerized in consideration of various standpoints such as an adhesion to a base material, a Tg of polymer (contributing to the film hardness), a solubility in solvent, a transparency, a lubricating property, and dust and stain preventing properties. Such vinyl monomer may be employed in a combination of plural kinds according to the purpose, and is preferably introduced within a range of 0-65 mol. % in total within the copolymer, more preferably within a range of 0-40 mol. % and particularly preferably within a range of 0-30 mol. %.

A vinyl monomer unit usable in combination is not particularly restricted and can be, for example, an olefin (such as ethylene, propylene, isoprene, vinyl chloride or vinylidene chloride), an acrylate ester (such as methyl acrylate, ethyl acrylate, 2-ethylhexyl acrylate or 2-hydroxyethyl acrylate), a methacrylate ester (such as methyl methacrylate, ethyl methacrylate, butyl methacrylate or 2-hydroxyethyl methacrylate), a styrene derivative (such as styrene, p-hydroxymethylstyrene or p-methoxystyrene), a vinyl ether (such as methyl vinyl ether, ethyl vinyl ether, cyclohexyl vinyl ether, hydroxyethyl vinyl ether, or hydroxybutyl vinyl ether), a vinyl ester (such as vinyl acetate, vinyl propionate, or vinyl cinnamate), an unsaturated carboxylic acid (such as acrylic acid, methacrylic acid, crotonic acid, maleic acid or itacolic acid), an acrylamide (such as N,N-dimethyl acrylamide, N-tert-butyl acrylamide or N-cyclohexyl acrylamide), a methacrylamide (such as N,N-dimethyl methacrylamide) or acrylonitrile.

The fluorine-containing polymer particularly useful in the invention is a random copolymer of perfluoroolefin and a vinyl ether or a vinyl ester. In particular, it preferably contains a group capable of a crosslinking reaction singly (for example a radical reactive group such as a (meth)acryloyl group or a ring-opening polymerizable group such as an epoxy group or an oxetanyl group). Such polymerization unit including a crosslinkable group preferably represents 5-70 mol. % of all the polymerization units of the polymer, particularly preferably 30-60 mol. %. Preferred polymers can be those described in JP-A Nos. 2002-243907, 2002-372601, 2003-26732, 2003-222702, 2003-294911, 2003-329804, 2004-4444, and 2004-45462.

Also in the fluorine-containing polymer of the invention, a polysiloxane structure is preferably introduced for providing an antistain property. A method of introducing the polyxiloxane structure is not particularly restricted and is preferably introduced by a method of introducing a polysiloxane block copolymerization component utilizing a silicone macroazo initiator as described in JP-A Nos. 6-93100, 11-189621, 11-228631 and 2000-313709, or by a method of introducing a polysiloxane graft copolymerization component utilizing a silicone macromer as described in JP-A Nos. 2-251555 and 2-308806. Examples of a particularly preferable compound include polymers of examples 1, 2 and 3 in JP-A No. 11-189621, and copolymers A-2 and A-3 in JP-A No. 2-251555. Such polysiloxane component is preferably contained by 0.5 to 10 mass % in the polymer, particularly preferably 1 to 5 mass %.

The polymer preferably employable in the invention has a molecular weight, in a mass-averaged molecular weight, of 5,000 or higher, preferably 10,000-500,000 and most preferably 15,000-200,000. A combined use of polymers of different average molecular weights allows to improve the coated surface state and the scratch resistance.

The aforementioned polymer may be used in combination with a curing agent having a polymerizable unsaturated group as described in JP-A Nos. 10-25388 and 2000-17028. There is also preferred a combined use with a fluorine-containing polyfunctional compound having a polymerizable unsaturated group as described in JP-A No. 2002-145952. The polyfunctional compound having a polymerizable unsaturated group can be, for example, the polyfunctional monomer described for the hard coat layer. Such compound has a large effect of improving the scratch resistance, particularly in case of a combination with a compound having a polymerizable unsaturated group in the main polymer.

In case the polymer itself does not have a sufficient curing property, a necessary curing property can be provided by blending a crosslinkable compound. For example, in case the main polymer has a hydroxyl group, various amino compounds are preferably employed as a curing agent. The amino compound employed as the crosslinking agent is for example a compound having a hydroxyalkylamino group and/or an alkoxyalkylamino group by two or more units in total, and more specifically can be a melamine compound, a urea compound, a benzoguanamine compound, or a glycoluryl compound.

A melamine compound is generally known to have a skeleton of a triazine ring to which a nitrogen atom is bonded, such as melamine, an alkylated melamine, methylolmelamine or an alkoxylated methylmelamine, but preferably contains a methylol group and/or an alkoxylated methyl group by two or more units in total within a molecule. More specifically there is preferred a methylolated melamine obtained by reacting melamine and formaldehyde under a basic condition, an alkoxylated melamine or a derivative thereof, and an alkoxylated melamine is particularly preferable in obtaining a satisfactory storability and a satisfactory reactivity in a curable resin composition. The methylolated melamine or alkoxylated methylmelamine to be employed as the crosslinkable compound is not particularly restricted, and there can also be utilized various resinous substances obtainable by a method described for example in Plastic Zairyo Koza, [8] urea and melamine resins (published by Nikkan Kogyo Shimbun).

Also a urea compound can be, in addition to urea, polymethylolated urea, alkoxylated methylurea as a derivative thereof, methylolated urea having a urone ring or alkoxylated methylurone. Also in the urea derivatives, various resinous substances described in the aforementioned literature can be employed.

In the low refractive index layer of the invention, a compound generating a radical or an acid by an irradiation with an ionizing radiation or heat can be employed.

A photoradical generator or a thermal radical generator can be those described in the film forming binder.

<Thermal Acid Generator>

Specific examples of the thermal acid generator include an aliphatic sulfonic acid and a salt thereof, an aliphatic carboxylic acid such as citric acid, acetic acid, or maleic acid and a salt thereof, an aromatic carboxylic acid such as benzoic acid, or phthalic acid and a salt thereof, an alkylbenzenesulfonic acid and an ammonium salt, an amine salt and a metal salt thereof, phosphoric acid and a phosphate ester of an organic acid.

Examples of commercially available material include Catalyst 4040, Catalyst 4040, Catalyst 4050, Catalyst 600, Catalyst 602, Catalyst 500 and Catalyst 296-9 (foregoing manufactured by Nippon Scitec Industries Co.), Nacure series 155, 1051, 5076, 4054J and block type Nacure series 2500, 5225, X49-110, 3525 and 4167 (foregoing manufactured by King Ltd.).

Such thermal acid generator is preferably employed in an amount of 0.01-10 parts by mass with respect to 100 parts by mass of the curable resin composition, and more preferably 0.1-5 parts by mass. The amount within such range provides a satisfactory storage stability of the curable resin composition and a satisfactory scratch resistance in the coated film.

[Photoacid Generator]

The photoacid generator can be, for example, (1) an onium salt such as an iodonium salt, a sulfonium salt, a phosphonium salt, a diazonium salt, an ammonium salt or a pyridinium salt; (2) a sulfone compound such as a β-ketoester, a β-sulfonylsulfone or an α-diazo compound thereof; (3) a sulfonate ester such as an alkylsulfonate ester, a haloalkylsulfonate ester, an arylfulsonate ester or an imisulfonate; (4) a sulfonimide compound; or (5) a diazomethane compound. Such photoacid generator is preferably employed in 0.01-10 parts by mass with respect to 100 parts by mass of the curable resin composition, more preferably 0.1-5 parts by mass.

The low refractive index layer may be formed by a gaseous process (vacuum evaporation, sputtering, ion plating or plasma CVD) or a coating method, but a coating method is preferable because it allows an inexpensive preparation. The low refractive index layer is constructed as an outermost layer of the optical film or an adjacent layer to the outermost layer.

The preparation of the low refractive index layer by a gaseous method can be achieved by vacuum evaporating or sputtering a low refractive index material for example a silicon compound or a fluorine-containing compound (such as MgF₂, or SiOₓ (1≦x≦2)) on the hard coat layer. In the preparation of the low refractive index layer by the gaseous method, a known method is applicable.

The preparation of the low refractive index layer by a coating method can be achieved by coating a liquid containing a low refractive index material for example a silicon compound or a fluorine-containing compound, on the hard coat layer. For example there can be employed a method of coating a liquid containing SiO₂ sol thereby forming a SiO₂ sol film, or a method of coating a liquid containing a fluorinated resin thereby forming a fluorinated resin layer.

The fluorinated resin is preferably formed by a crosslinking or polymerizing reaction of a fluorine-containing compound, having a crosslinkable or polymerizable functional group such as a thermally curable functional group or a functional group curable with an ionizing radiation.

The low refractive index layer preferably has a refractive index lower than that of the transparent substrate, preferably 1.30-1.50, more preferably 1.35-1.48, further preferably 1.38-1.46 and particularly preferably 1.40-1.45.

The low refractive index layer generally has a thickness of about 50-200 nm, preferably 60-150 nm, more preferably 70-120 nm and particularly preferably 75-100 nm.

The low refractive index layer has a haze preferably of 5% or less, more preferably 3% or less, particularly preferably 2% or less and most preferably 1% or less.

Also in a Taber test according to JIS K5400, the low refractive index layer preferably shows an abrasion amount of a test piece as small as possible between before and after the test.

In the preferable low refractive index layer, descriptions in JP-A No. 2000-100005, 2001-100007, 2001-188104, 2001-318207, 2002-55205, 2002-71904, 2002-82207, 2002-131507, 2002-131514, 2002-116323, 2002-148404, 2002-156508, 2002-243907, 2002-243905, 2002-372601, 2003-26732, 2003-222702, 2003-222704, 2003-227901, 2002-294911, 2003-329804, 2004-22278, 2004-4444, 2004-42278, 2004-45462, 2004-69866, 2004-93947, 2004-163610, and 2004-170919 are particularly preferably applicable.

(High Refractive Index Layer)

For obtaining an optical film of a superior antireflection property, a layer (high refractive index layer and/or medium refractive index layer) having a refractive index higher than that of the low refractive index layer is preferably provided on the optical film (for example between the hard coat layer and the low refractive index layer). A high refractive index or a medium refractive index means a relative difference in the refractive index between the layers, and a high refractive index layer has a refractive index higher than that of a medium refractive index layer.

The high refractive index layer may be formed by a gaseous process (vacuum evaporation, sputtering, ion plating or plasma CVD) or a coating method, but a coating method is preferable because it allows an inexpensive preparation.

The preparation of the high refractive index layer by a gaseous method can be achieved by vacuum evaporating or sputtering a high refractive index material on the hard coat layer. In the preparation of the high refractive index layer by the gaseous method, a known method is applicable.

The preparation of the high or medium refractive index layer by a coating method is preferably achieved by finely dispersing, in the film, inorganic fine particles of a high refractive index (such as titanium dioxide, zirconium oxide, aluminum oxide, tin oxide, ATO, ITO, or zinc oxide). As to the dispersing method, items that have been explained for the antistatic layer are applicable.

Also in the high or medium refractive index layer, there can be advantageously employed also a binder obtained by a crosslinking or polymerizing reaction of an ionizing radiation-curable compound containing an aromatic group and/or a halogen other than fluorine (such as Br, I, or Cl), or an ionizing radiation-curable compound containing S, N or P atom. In the high or medium refractive index layer, a refractive index can be suitably controlled, and, in case fine particles of a high refractive index are contained, the refractive index can be regulated by controlling a content of the fine particles in the film. Also a thickness of the high or medium refractive index layer can be suitably regulated.

The high refractive index layer preferably has a refractive index of 1.65-2.40, more preferably 1.70-2.20, further preferably 1.75-2.10 and particularly preferably 1.80-2.10. The medium refractive index layer preferably has a refractive index of 1.55-1.80, more preferably 1.60-1.80, further preferably 1.60-1.75 and particularly preferably 1.60-1.70.

The high or medium refractive index layer preferably contains a binder of an organic compound. Also as in the case of the hard coat layer, the binder is preferably a cured substance of a compound having a crosslinkable or polymerizable functional group, and is preferably formed by a crosslinking or polymerizing reaction of a compound curable with an ionizing radiation.

The high or medium refractive index layer has a haze preferably of 5% or less, more preferably 3% or less, particularly preferably 2% or less and most preferably 1% or less.

The high or medium refractive index layer preferably has a strength of H or higher in a pencil hardness test according to JIS K5400, more preferably 2H or higher and most preferably 3H or higher. Also in a Taber test according to JIS K5400, an abrasion amount of a test piece is preferably as small as possible between before and after the test.

A preferred high or medium refractive index layer is described, for example, in JP-A No. 11-153703, 2001-166104, 2003-227901, 2004-29705 and 2004-29705.

(Surface Irregularities of Optical Film)

In the optical film, it is possible to form irregularities on a surface at the side of the antistatic layer, thereby providing an antiglare property. A known method can be employed for forming the surface irregularities. In the invention, there is preferred a method of pressing a plate having surface irregularities under a higher pressure to the film surface (embossing method) thereby forming surface irregularities, or a method of including particles in any one of the layers on the optical film as an antiglare layer, thereby forming the surface irregularities.

In case of forming the surface irregularities by an embossing, a known method is applicable but the irregularities are preferably formed by a method described in JP-A Nos. 2000-275401, 2000-275404, 2000-329905 and 2004-4404.

For forming the surface irregularities on the optical film, it is particularly preferable to include particles of an average particle size of 0.2-10 μm in a coated layer thereby forming the surface irregularities.

It is furthermore preferable to form irregularities on the surface of the optical film by forming the aforementioned optical interference layer (high refractive index layer, medium refractive index layer, low refractive index layer etc.) on the antiglare layer.

In these methods (such as formation of antiglare layer), descriptions in JP-A Nos. 2000-111713, 2001-100004, 2001-281406, 2001-281407, 2001-343503, 2001-343504, 2002-40204, 2002-98804, 2002-169001, 2002-202402, 2002-267814, 2002-267817, 2002-277602 and 2003-4903 are particularly preferably applicable.

(Light Diffusing Layer)

A light diffusing layer can be constructed for improving visibility (a glitter failure or a viewing angle property of a liquid crystal display apparatus) when the optical film is mounted on an image display surface.

The light diffusing layer can be formed by constructing layer, including particles of an average particle size of 0.2-10 μm, between the transparent substrate and the outermost layer.

In the light diffusing layer, there is preferably provided a difference in the refractive index, between the refractive index of the particles and that of a matrix of the layer, and such difference is preferably 0.03 to 0.5, more preferably 0.03 to 0.4 and particularly preferably 0.05 to 0.3.

As the particles of an average particle size of 0.2-10 μm, particles of plural kinds with different average particle sizes may be employed in combination. It is also preferable to utilize particles of plural different materials in combination.

The layer containing particles of an average particle size of 0.2-10 μm preferably contains a binder of an organic compound. Also, as in the antistatic layer and the hard coat layer, the binder is preferably a cured substance of a compound having a crosslinkable or polymerizable functional group, and is preferably formed by a crosslinking or polymerizing reaction of a compound curable with an ionizing radiation. The binder for the light diffusing layer is preferably selected from materials described as the binder for the antistatic layer and the hard coat layer.

The light diffusing layer preferably has a haze of 3-80%, more preferably 5-60%, particularly preferably 7-50%, and most preferably 10-40%.

In the light diffusing layer, descriptions in JP-A Nos. 2003-43261, 2003-4903, 2003-270409 and 2004-184860 are particularly preferably applicable.

(Forming Method of Optical Film)

In the invention, each layer constituting the optical film is preferably formed by a co-casting method or a coating method. In case of formation by a coating method, each layer can be formed by a dip coating method, an air-knife coating method, a die coating method, a curtain coating method, a roller coating method, a wire bar coating method, a gravure coating method, a microgravure coating method or an extrusion coating method (described in U.S. Pat. No. 2,681,294). Also two or more layers may be coated simultaneously. A simultaneous coating method is described in U.S. Pat. Nos. 2,761,791, 2,941,898, 3,508,947, and 3,526,528, and Yuji Harasaki, “Coating Engineering”, p. 253, Asakura Shoten (1973). Among these coating methods, a die coating method, a wire bar coating method, a gravure coating method or a microgravure coating method is preferable, and a die coating method or a microgravure coating method is particularly preferable.

In case of preparing the antistatic layer or the hard coat layer to be employed in the invention by a coating method, it is preferably prepared by a die coating method or a gravure coating method, and particularly preferably prepared by a die coating method.

Particularly in case of constructing the antistatic layer of the invention as an adjacent layer to the transparent substrate (cellulose acylate film), there is preferred a coating method in which a hard material such as a gravure roll or a wired bar does not directly contact a coated surface of the cellulose acylate film, and it is most preferable, in preventing a scratch on the cellulose acylate film, to coat a coating liquid for the antistatic layer by a die coating method.

Also in case of constructing the hard coat layer of the invention as an adjacent layer to the antistatic layer, there is preferred a coating method in which a hard material such as a gravure roll or a wired bar does not directly contact a surface of the antistatic layer, and it is most preferable, in preventing a scratch on the antistatic layer, to coat a coating liquid for the hard coat layer by a die coating method.

Also the antistatic layer is preferably formed, in a preparation of the transparent substrate, within a process from a casting of the cellulose acylate film to a winding thereof. It is furthermore preferable to construct both the antistatic layer and the hard coat layer within a process from a casting of the cellulose acylate film to a winding thereof. Such preparation of the optical film within a continuous process allows to improve the productivity thereby realizing a low cost of the optical film.

Also the antistatic layer and the hard coat layer applicable to the present invention are preferably formed by a co-casting method.

The co-casting method is described for example in JP-B Nos. 44-20235, 62-43846 and 60-27562, and JP-A Nos. 53-134869, 56-162617, 61-18943, 61-94724, 61-94725, 61-104813, 61-158414, 61-158413, 61-158414, 61-158413, 1-122419, 6-134933, 10-058514, 11-198285, 2000-317960, 2002-221620, 2003-80541 and 2003-14933.

[Optical Film]

The optical film is preferably formed as an antireflection film, an antiglare film or a light diffusing film, by constructing the aforementioned layers.

The optical film of the invention, in order to prevent deposition of particles (such as dusts) on the surface, preferably has a surface resistivity, on a surface of the side of the antistatic layer, preferably of 1×10¹⁴ Ω/sq. or less, more preferably 1×10¹² Ω/sq. or less, further preferably 1×10¹¹ Ω/sq. or less, particularly preferably 1×10⁹ Ω/sq. or less, and most preferably 1×10⁸ Ω/sq. or less.

Also the optical film of the invention, in order to improve a physical strength (such as scratch resistance), preferably has a dynamic friction coefficient, on a surface of the side of the antistatic layer, preferably of 0.25 or less. The dynamic friction coefficient mentioned above means, when a stainless steel rigid ball of a diameter of 5 mm is moved under a load of 0.98 N and with a speed of 60 cm/min on the surface at the side of the antistatic layer, a dynamic friction coefficient between the surface at the side of the antistatic layer and the stainless steel rigid ball of a diameter of 5 mm. It is preferably 0.17 or less, and particularly preferably 0.15 or less.

The optical film preferably has a hardness of H or higher in a pencil hardness test according to JIS K5400, more preferably 2H or higher and most preferably 3H or higher. Also in a Taber test according to JIS K5400, an abrasion amount of a test piece is preferably as small as possible between before and after the test.

Also for improving the antistain property, the optical film preferably has, on a surface thereof at the side of the antistatic layer, preferably has a contact angle to water of 90° or higher, more preferably 95° or higher and particularly preferably 100° or higher.

In case the optical film does not have an antiglare function or a light diffusing function, a haze thereof is preferably as low as possible.

In case the optical film has an antiglare function or a light diffusing function, a haze thereof is preferably 0.5-50%, more preferably 1-40% and most preferably 1-30%.

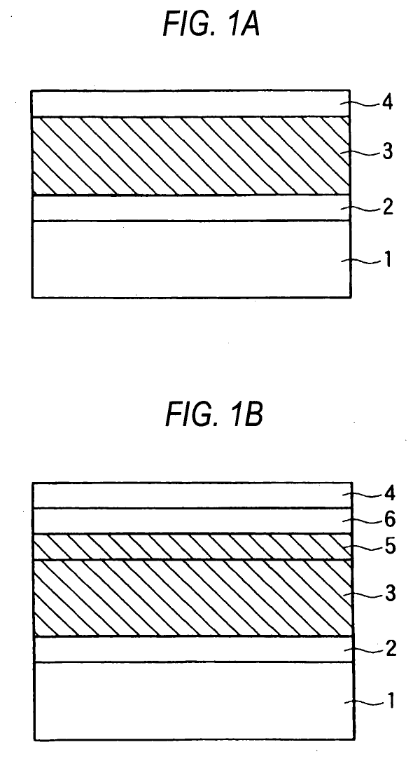

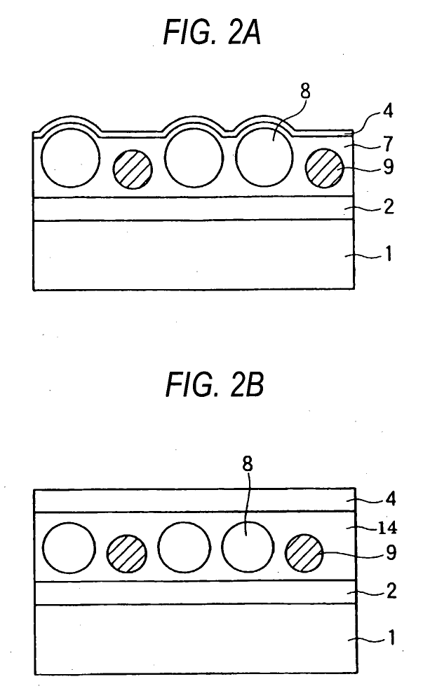

FIGS. 1A, 1B, 2A and 2B are schematic cross-sectional views showing preferred embodiments of the optical film, wherein FIGS. 1A and 1B are schematic cross-sectional views of two embodiments a, b, schematically showing layer configurations of optical films with an excellent antireflective property, and FIGS. 2A and 2B are schematic cross-sectional views of two embodiments, including a layer configuration a of an optical film having an antiglare property and a layer configuration b of an optical film having a light diffusing property. In the drawings, there are shown 1: transparent substrate, 2: antistatic layer, 3: hard coat layer, 4: low refractive index layer (outermost layer), 5: medium refractive index layer, 6: high refractive index layer, 7: antiglare layer, 8: particles with an average particle size of 0.2-10 μm, 9: particles with an average particle size of 0.2-10 μm, 10: adhesive layer, 11, 12: protective film of a polarizing film, 13: polarizing film, and 14: light diffusing layer.

(Protective Film for Polarizing Plate)

The optical film can be employed as a protective film of a polarizing film (protective film for polarizing plate). In such case, a surface of the transparent substrate, opposite to the side having the antistatic layer, namely a surface to be adhered to the polarizing film, preferably has a contact angle to water of 40° or less, more preferably 30° or less and particularly preferably 25° or less. A contact angle of 40° or less is effective for improving an adhesion to a polarizing film principally constituted of polyvinyl alcohol. Such contact angle can be regulated by process conditions of a following saponification process.

A protective film for the polarizing plate in the invention can be prepared by following two methods:

(1) a method of forming, on a surface of a transparent substrate subjected to a saponification process, aforementioned layers (such as an antistatic layer, a hard coat layer, a low refractive index layer, a medium refractive index layer, and a high refractive index layer), by coating;

(2) A method of forming, on a surface of a transparent substrate, aforementioned layers (such as an antistatic layer, a hard coat layer, a low refractive index layer, a medium refractive index layer, and a high refractive index layer), by coating, and then executing a saponification process on a surface to be adhered to the polarizing film.

In the method (1), in case the transparent substrate is saponified only on a surface thereof, the layers are coated on an unsaponified side. In case the transparent substrate is saponified on both surfaces thereof, it is preferable to execute a surface treatment such as a corona discharge treatment, a glow discharge treatment or a flame treatment on a surface of the transparent substrate at a side on which the layer are to be coated, and then to coat the layers.

In the method (2), it is preferable to immerse the entire optical film in a saponifying solution. In this case, it is also possible to immerse the optical film after protecting a surface thereof having different layers with a protective film, into the saponifying solution, thereby saponifying a surface of the transparent substrate to be adhered to the polarizing film.

It is also possible to coat a saponifying solution on a surface of the transparent substrate to be adhered to the polarizing film thereby saponifying a surface of the transparent substrate to be adhered to the polarizing film.

It is possible to further reduce the cost by executing the saponification process after the aforementioned optical performances (such as antireflective property, antiglare property, light diffusing property and the like) are provided to the protective film, and the method (2) is particularly preferable in producing the protective film for the polarizing plate inexpensively.

The protective film for the polarizing plate preferably satisfy the performances described for the optical film, in the optical performance (antireflective property, antiglare property, light diffusing property and the like), physical performance (scratch resistance and the like), chemical resistance, antistain performance (stain resistance and the like), antiweather performance (moisture-heat resistance, and light fastness) and antidust performance.

Therefore, the surface at the side of the antistatic layer preferably has a surface resistivity of 1×10¹⁴ Ω/sq. or less, more preferably 1×10¹² Ω/sq. or less, further preferably 1×10¹¹ Ω/sq. or less, particularly preferably 1×10⁹ Ω/sq. or less, and most preferably 1×10⁸ Ω/sq. or less.

Also the surface at the side of the antistatic layer preferably has a dynamic friction coefficient of 0.25 or less, preferably 0.17 or less and particularly preferably 0.15 or less.

Also the surface at the side of the antistatic layer preferably has a contact angle to water of 90° or larger, more preferably 95° or larger and particularly preferably 100° or larger.

(Saponification Process)

The saponification process is preferably executed by a known method, for example by immersing a transparent substrate or an optical film in an alkali solution for a suitable period.

The alkali solution is preferably an aqueous solution of potassium hydroxide or sodium hydroxide. A preferred concentration is 0.5-3 N, particularly preferably 1-2 N. A preferred temperature of the alkali solution is 30-70° C., particularly preferably 40-60° C.

After the immersion in the alkali solution, the film is preferably rinsed sufficiently with water or immersed in a dilute acid to neutralize the alkali component, in order that the alkali component does not remain in the film.

The saponification process renders the surface of the transparent substrate hydrophilic. The protective film for the polarizing plate is used by adhering the hydrophilized surface of the transparent substrate with the polarizing film.

The hydrophilized surface is effective for improving the adhesion to the polarizing film principally constituted of polyvinyl alcohol.

The saponification process is preferably executed in such a manner that a surface of the transparent substrate, opposite to the side having the antistatic layer, has a contact angle to water of 40° or less, more preferably 30° or less and particularly preferably 25° or less.

(Polarizing Plate)

A polarizing plate has an optical film of the invention as at least one of the protective films for the polarizing plate (polarizing plate protective films). The polarizing plate protective film preferably has, on a surface of the transparent substrate opposite to the side of the antistatic layer, namely on a surface to be adhered to the polarizing film, a contact angle to water of 40° or larger as explained above.

The use of the optical film as the polarizing plate protective film allows to obtain a polarizing plate excellent in the aforementioned optical performances, also to achieve a significant cost reduction and to realize a thinner display apparatus.

Also a polarizing plate employing an optical compensation film, having an optical anisotropy as will be described later, in the other of the two protective films, can further improve the contrast of a liquid crystal display apparatus in a bright environment and significantly expanding the viewing angle in the vertical directions and lateral directions.

(Optical Compensation Film)

The aforementioned optical compensation film (phase difference film) can improve the viewing angle characteristics of a liquid crystal display apparatus.

The optical compensation film can be of a known type, but, for the purpose of expanding the viewing angle, there is preferred an optical compensation film which includes an optically anisotropic layer formed by a compound having a discotic structural unit and in which an angle formed by the discotic compound and a film plane changes along the direction of depth of the optically anisotropic layer. More specifically, the compound having the discotic structural unit is preferably aligned in a hybrid alignment, a bent alignment, a twisted alignment, a homogenous alignment, or a homeotropic alignment, particularly preferably a hybrid alignment.

The aforementioned angle preferably increases with local fluctuations, along with an increase in the distance from the surface of the substrate of the optical compensation film.

There is also preferred an embodiment in which the optically anisotropic layer further contains a cellulose

ester, an embodiment in which an alignment layer is formed between the optical anisotropic layer and the transparent substrate of the optical compensation film, an embodiment in which the transparent substrate of the optical compensation film having the optically anisotropic layer has an optically negative anisotropy and an optical axis is present in a normal direction to the surface of the transparent substrate, or an embodiment satisfying a following condition:
20≦{(nx+ny)/2−nz}×d≦400
wherein nx is a refractive index in a phase delaying axis direction in the film plane (maximum refractive index in the plane), ny is a refractive index in a direction perpendicular to a phase delaying axis in the plane, nz is a refractive index in a direction perpendicular to the plane and d is a thickness (nm) of the optically anisotropic layer.

In case of employing the optical compensation film as a protective film for the polarizing film, a surface of the side to be adhered with the polarizing film is preferably subjected to a saponification process, which is preferably executed according to the aforementioned saponification method.

(Image Display Apparatus)

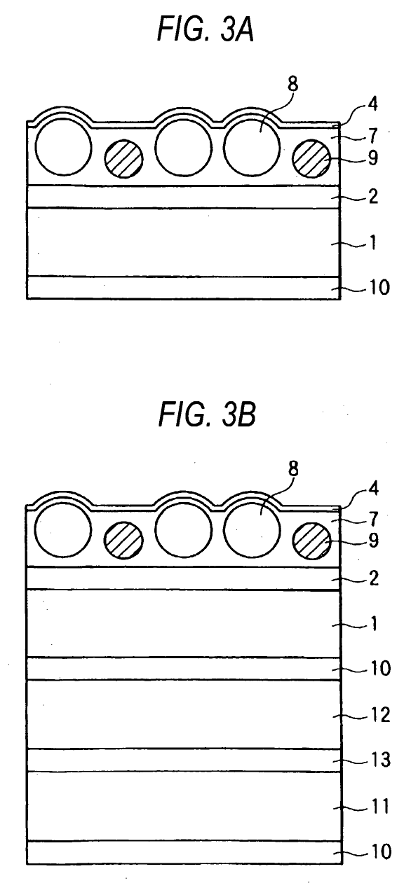

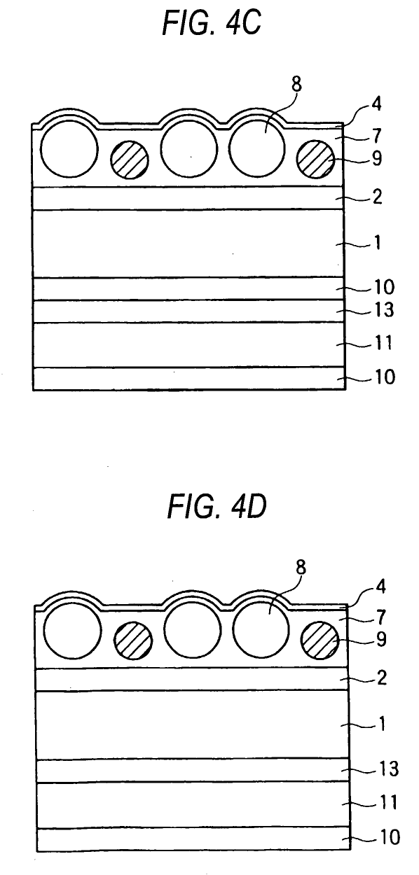

The optical film can be applied to an image display apparatus such as a liquid crystal display apparatus (LCD), a plasma display panel (PDP), an electroluminescence display (ELD) or a cathode ray tube (CRT). The optical film is adhered, at the side of the transparent substrate thereof, to the image display surface of the image display apparatus. FIGS. 3A, 3B, 4A and 4B are schematic cross-sectional views showing various embodiments of application of the optical film to the image display apparatus. In FIGS. 3A, 3B, 4A and 4B, numbers indicating constituent layers and components are same as those in FIGS. 1A, 1B, 2A and 2B.

FIG. 3A shows a preferred embodiment of applying the optical film to an image display apparatus, particularly a PDP, an ELD or a CRT. In the optical film, the transparent substrate 1 can be adhered, across an adhesive layer 10, to the image display surface of the image display apparatus.

FIGS. 3B, 4C and 4D indicate preferred embodiments of applying the optical film to an LCD.

In FIG. 3B, the transparent substrate 1 of the optical film is adhered, across an adhesive layer 10, to a protective film 12 of a polarizing film 13. A side of the polarizing film 13, the side being adjacent to a protective film 11, can be adhered, across an adhesive layer 10, to a liquid crystal display surface of the liquid crystal display apparatus.

In FIG. 4C, the transparent substrate of the optical film (the protective film of the polarizing plate) is, across the adhesive layer, adhered to the polarizing film 13. A side of the polarizing film 13, the side being adjacent to a protective film 11, can be adhered, across an adhesive layer 10, to a liquid crystal display surface of the liquid crystal display apparatus.

In FIG. 4D, the transparent substrate of the optical film (the protective film of the polarizing plate) is directly adhered to the polarizing film 13. A side of the polarizing film 13, the side being adjacent to a protective film 11, can be adhered, across an adhesive layer 10, to a liquid crystal display surface of the liquid crystal display apparatus.

In the adhesive layer 10, additives such as particles or a dye may be added.

The optical film and the polarizing plate of the invention can be advantageously employed in a transmission, reflective or semi-reflective liquid crystal display apparatus of various modes, such as twisted nematic (TN), super twisted nematic (STN), vertical alignment (VA), in-plain switching (IPS) or optically compensated bend cell (OCB).

Particularly in a liquid crystal display apparatus of TN mode or IPS mode, as described in JP-A No. 2001-100043, a polarizing plate utilizing the aforementioned optical compensation film and the optical film as the protective films may be employed to significantly improve the viewing angle characteristics and the antireflective characteristics.

Also a combined use with a commercially available luminance improving film (polarized light separating film having a polarized light selecting layer, such as D-BEF (trade name) manufactured by Sumitomo-3M Co.) allows to obtain a further improved visibility in a transmission or semi-transmission liquid crystal display apparatus.

Also a combination with a λ/4-plate can be employed in a polarizing plate for a reflective liquid crystal display or a surface protective plate for an organic EL display, for reducing a reflected light from the surface and from the interior.

### EXAMPLE 1

In the following, the present invention will be clarified further by examples, but the present invention should not be construed as restricted by these examples.

(Antistatic Layer Coating Liquid (A))

In 12.58 parts by mass of methyl ethyl ketone, 42.50 parts by mass of cyclohexanone and 2.17 parts by mass of cellulose acetate (acetyl group substitution degree: 2.4, polymerization degree: 180) were added and agitated to obtain a cellulose acetate solution.

In the cellulose acetate solution, 42.75 parts by mass of a commercially available dispersion of antimony-containing tin oxide (ATO) (SNS-10M, solid concentration 30 mass %, manufactured by Ishihara Sangyo Co.) were added and agitated. The SNS-10M is a dispersion in methyl ethyl ketone (MEK), prepared by dispersing, with a dispersing agent, SN-100P (ATO, specific surface area: 80 m²/g, manufactured by Ishihara Sangyo Co.), which is surface treated with a coupling agent.

The solution was filtered with a polypropylene filter of a pore size of 0.4 μm to obtain an antistatic layer coating liquid (A).

(Antistatic Layer Coating Liquid (B))

In a commercially available dispersion of antimony-containing tin oxide (ATO) (SNS-10M, solid concentration 30 mass %, solvent MEK, manufactured by Ishihara Sangyo Co.), the MEK solvent was replaced by cyclohexanone to obtain an ATO dispersion of a solid concentration of 30 mass %.

In 4.08 parts by mass of cyclohexanone, 51.00 parts by mass of methylene chloride and 2.17 parts by mass of cellulose acetate (acetyl group substitution degree: 2.4, polymerization degree: 180) were added and agitated to obtain a cellulose acetate solution.

In the cellulose acetate solution, 42.75 parts by mass of the aforementioned ATO dispersion were added and agitated.

The solution was filtered with a polypropylene filter of a pore size of 0.4 μm to obtain an antistatic layer coating liquid (B).

(Antistatic Layer Coating Liquid (C))

In a commercially available dispersion of antimony-containing tin oxide (ATO) (SNS-10M, solid concentration 30 mass %, manufactured by Ishihara Sangyo Co.), the MEK solvent was replaced by cyclohexanone to obtain an ATO dispersion of a solid concentration of 30 mass %.

In 38.08 parts by mass of cyclohexanone, 2.17 parts by mass of cellulose acetate (acetyl group substitution degree: 2.4, polymerization degree: 170) were added and agitated to obtain a cellulose acetate solution.

In the cellulose acetate solution, 42.75 parts by mass of the aforementioned ATO dispersion and 17.00 parts by mass of methyl isobutyl ketone were added and agitated.

The solution was filtered with a polypropylene filter of a pore size of 0.4 μm to obtain an antistatic layer coating liquid (C).

(Antistatic Layer Coating Liquid (D))

In 55.08 parts by mass of methyl ethyl ketone, 2.17 parts by mass of cellulose acetate (acetyl group substitution degree: 2.4, polymerization degree: 170) were added and agitated to obtain a cellulose acetate solution.

In the cellulose acetate solution, 42.75 parts by mass of a commercially available dispersion of antimony-containing tin oxide (ATO) (SNS-10M, solid concentration 30 mass %, manufactured by Ishihara Sangyo Co.), were added and agitated.

The solution was filtered with a polypropylene filter of a pore size of 0.4 μm to obtain an antistatic layer coating liquid (D).

(Antistatic Layer Coating Liquid (E))

In a commercially available dispersion of antimony-containing tin oxide (ATO) (SNS-10M, solid concentration 30 mass %, solvent MEK, manufactured by Ishihara Sangyo Co.), the MEK solvent was replaced by cyclohexanone to obtain an ATO dispersion of a solid concentration of 30 mass %.

In 40.80 parts by mass of cyclohexanone, 3.34 parts by mass of cellulose acetate (acetyl group substitution degree: 2.4, polymerization degree: 170) were added and agitated to obtain a cellulose acetate solution.

In the cellulose acetate solution, 38.86 parts by mass of the aforementioned ATO dispersion and 17.00 parts by mass of methyl isobutyl ketone were added and agitated.

The solution was filtered with a polypropylene filter of a pore size of 0.4 μm to obtain an antistatic layer coating liquid (E).

(Antistatic Layer Coating Liquid (F))

In a commercially available dispersion of antimony-containing tin oxide (ATO) (SNS-10M, solid concentration 30 mass %, solvent MEK, manufactured by Ishihara Sangyo Co.), the MEK solvent was replaced by cyclohexanone to obtain an ATO dispersion of a solid concentration of 30 mass %.

In 43.53 parts by mass of cyclohexanone, 4.50 parts by mass of cellulose acetate (acetyl group substitution degree: 2.4, polymerization degree: 170) were added and agitated to obtain a cellulose acetate solution.

In the cellulose acetate solution, 34.97 parts by mass of the aforementioned ATO dispersion and 17.00 parts by mass of methyl isobutyl ketone were added and agitated.

The solution was filtered with a polypropylene filter of a pore size of 0.4 μm to obtain an antistatic layer coating liquid (F).

(Antistatic Layer Coating Liquid (G))

In a commercially available dispersion of antimony-containing tin oxide (ATO) (SNS-10M, solid concentration 30 mass %, solvent MEK, manufactured by Ishihara Sangyo Co.), the MEK solvent was replaced by cyclohexanone to obtain an ATO dispersion of a solid concentration of 30 mass %.

In 40.80 parts by mass of cyclohexanone, 2.59 parts by mass of cellulose acetate (acetyl group substitution degree: 2.4, polymerization degree: 170) were added and agitated to obtain a cellulose acetate solution.

In the cellulose acetate solution, 38.86 parts by mass of the aforementioned ATO dispersion, 17.00 parts by mass of methyl isobutyl ketone and 0.75 parts by mass of an isocyanate group-containing curing agent (Millionate MR-400, manufactured by Nippon Polyurethane Co.) were added and agitated.

The solution was filtered with a polypropylene filter of a pore size of 0.4 μm to obtain an antistatic layer coating liquid (G).

(Antistatic Layer Coating Liquid (H))

In a reactor equipped with an agitator and a reflux condenser, 120 parts by mass of methyl isobutyl ketone, 100 parts by mass of 3-acryloxypropyl trimethoxysilane (KBM-5103, manufactured by Shin-etsu Chemical Co.) and 3 parts by mass of diisopropoxy aluminum ethylacetacetate (trade name: Chelope EP-12, manufactured by Hope Chemical Co.) were added and mixed, then 30 parts by mass of ion-exchanged water were added and a reaction was conducted for 4 hours at 60° C. The reaction mixture was cooled to the room temperature to obtain a solution of an organosilane compound A (solid concentration: 29 mass %). It has a mass-averaged molecular weight of 1,600, and, within components equal to or larger than oligomer components, components with a molecular weight of 1,000-20,000 represented 100%. Also in a gas chromatography analysis, 3-acryloxypropyltrimethoxysilane utilized as the raw material scarcely remained.

In a commercially available dispersion of antimony-containing tin oxide (ATO) (SNS-10M, solid concentration 30 mass %, manufactured by Ishihara Sangyo Co.), the MEK solvent was replaced by cyclohexanone to obtain an ATO dispersion of a solid concentration of 30 mass %.

In 40.80 parts by mass of cyclohexanone, 2.59 parts by mass of cellulose acetate (acetyl group substitution degree: 2.4, polymerization degree: 170) were added and agitated to obtain a cellulose acetate solution.

In the cellulose acetate solution, 38.86 parts by mass of the aforementioned ATO dispersion, 15.16 parts by mass of methyl isobutyl ketone and 2.59 parts by mass of the solution of organosilane compound A were added and agitated.

The solution was filtered with a polypropylene filter of a pore size of 0.4 μm to obtain an antistatic layer coating liquid (H).

(Antistatic Layer Coating Liquid (I))

In 54.88 parts by mass of methyl ethyl ketone, 2.17 parts by mass of a mixture of dipentaerythritol pentaacrylate and dipentaerythritol hexaacrylate (DPHA, manufactured by Nippon Kayaku Co.) were added and agitated to obtain a DPHA solution.

In the DPHA solution, 42.75 parts by mass of a commercially available dispersion of antimony-containing tin oxide (ATO) (SNS-10M, solid concentration 30 mass %, manufactured by Ishihara Sangyo Co.), and 0.20 parts by mass of a polymerization initiator (Irgacure 184, manufactured by Ciba Specialty Chemical Inc.) were added and agitated.

The solution was filtered with a polypropylene filter of a pore size of 0.4 μm to obtain an antistatic layer coating liquid (I).

(Antistatic Layer Coating Liquid (J))

In 76.00 parts by mass of cyclohexanone, 19.00 parts by mass of methyl isobutyl ketone, and 5.00 parts by mass of cellulose acetate (acetyl group substitution degree: 2.4, polymerization degree: 170) were added and agitated to obtain a cellulose acetate solution.

The solution was filtered with a polypropylene filter or a pore size of 0.4 μm to obtain a coating liquid (J) not containing the conductive material.

### Preparation of Hard Coat Layer Coating Liquid (I)

In 45.0 parts by mass of a mixture of dipentaerythritol pentaacrylate and dipentaerythritol hexaacrylate (DPHA, manufactured by Nippon Kayaku Co.), 2.0 parts by mass of a polymerization initiator (Irgacure 907, manufactured by Ciba Specialty Chemical Inc.), 5.0 parts by mass of an organosilane compound (KBM-5103, manufactured by Shin-etsu Chemical Co.), 40.0 parts by mass of methyl isobutyl ketone and 8.0 parts by mass of cyclohexanone were added and agitated.

The mixture was filtered with a polypropylene filter of a pore size of 30 μm to obtain a hard coat layer coating liquid (I).

### Preparation of Hard Coat Layer Coating Liquid (II)

In 285.0 parts by mass of a transparent high refractive index hard coat material containing zirconium oxide fine particles (Desolite Z7404, manufactured by JSR Corp., solid concentration: 60 mass %, zirconium oxide particle content: 70 mass % (to solids), average particle size of zirconium oxide particles: about 20 nm, solvent composition: MIBK/MEK=9/1), 85.0 parts by mass of a mixture of dipentaerythritol pentaacrylate and dipentaerythritol hexaacrylate (DPHA, manufactured by Nippon Kayaku Co.), 28.0 parts by mass of an organosilane compound (KBM-5103, manufactured by Shin-etsu Chemical Co.), 60.0 parts by mass of methyl isobutyl ketone and 17.0 parts by mass of methyl ethyl ketone were added and agitated. A coated film obtained by coating and ultraviolet curing this solution had a refractive index of 1.61.

In this solution, 35.0 parts by mass of a 30 mass % methyl isobutyl ketone dispersion of crosslinked and classified PMMA particles of an average particle size of 3.0 μm (refractive index: 1.49, MXS-300, manufactured by Soken Chemical Co.), prepared by a dispersion in a Polytron disperser at 10,000 rpm, and 90.0 parts by mass of a 30 mass % methyl ethyl ketone dispersion of silica particles of an average particle size of 1.5 μm (refractive index: 1.46, Seahoster KE-P150, manufactured by Nippon Shokubai Co.) prepared in a similar manner, were added and agitated.

The mixture was filtered with a polypropylene filter of a pore size of 30 μm to obtain a light diffusion hard coat layer coating liquid (II).

### Preparation of Hard Coat Layer Coating Liquid (III)

In the hard coat layer coating liquid (II), 2.0 parts by mass of a 30 mass % methyl ethyl ketone dispersion of conductive particles of an average particle size of 3.0 μm (Brite 41GNR30-EH, manufactured by Nippon Chemical Industrial Co. were added and agitated. The conductive particles had an S value of 2.0 or less.

The mixture was filtered with a polypropylene filter of a pore size of 30 μm to obtain a light diffusion hard coat layer coating liquid (III).

### Preparation of Hard Coat Layer Coating Liquid (IV)

In 55.0 parts by mass of a mixture of dipentaerythritol pentaacrylate and dipentaerythritol hexaacrylate (DPHA, manufactured by Nippon Kayaku Co.), 2.0 parts by mass of a polymerization initiator (Irgacure 907, manufactured by Ciba Specialty Chemical Inc.), 8.0 parts by mass of an organosilane compound (KBM-5103, manufactured by Shin-etsu Chemical Co.), 30.0 parts by mass of methyl isobutyl ketone and 5.0 parts by mass of methyl ethyl ketone were added and agitated. A coated film obtained by coating and ultraviolet curing this solution had a refractive index of 1.53.

In this solution, 25.0 parts by mass of a methyl isobutyl ketone dispersion (solid concentration: 30 mass %) of crosslinked polystyrene particles of an average particle size of 3.5 μm (refractive index: 1.61), prepared by a dispersion in a Polytron disperser at 10,000 rpm, 8.0 parts by mass of a methyl isobutyl ketone dispersion (solid concentration: 30 mass %) of crosslinked acryl-styrene particles of an average particle size of 3.5 μm (refractive index: 1.56) prepared in a similar manner, and 0.5 parts by mass of a methyl isobutyl ketone dispersion (solid concentration: 30 mass %) of conductive particles of an average particle size of 3.5 μm (Micropearl AU-2035, manufactured by Sekisui Chemical Co.) were added and agitated.

The mixture was filtered with a polypropylene filter of a pore size of 30 μm to obtain a hard coat layer coating liquid (IV).

The aforementioned materials were used to prepare optical film samples of following Examples 1-1 to 1-25 and Comparative Examples 1-A and 1-B.

### EXAMPLE 1-1

On a triacetyl cellulose film of a thickness of 80 μm and a width of 1340 mm (TAC-TD80U, manufactured by Fuji Photo Film Co., Ltd.), the aforementioned antistatic layer coating liquid (A) was coated with a die coating method. It was dried for 150 seconds at 100° C. to obtain an antistatic layer of a thickness of 0.2 μm. Then, on the antistatic layer, the hard coat layer coating liquid (I) was coated by a die coating method. After drying for 150 seconds at 100° C., the coated layer was cured, under a nitrogen purging (oxygen concentration of 0.1% or less), by an ultraviolet irradiation of an irradiation intensity of 400 mW/cm² and an irradiation amount of 250 mJ/cm² utilizing an air-cooled metal halide lamp of 160 W/cm (manufactured by Eyegraphics Co.) to obtain a hard coat layer of a thickness of 2.5 μm. In this manner an optical film of Example 1-1 was prepared.

### EXAMPLE 1-2

An optical film of Example 1-2 was prepared in the identical manner as in Example 1-1, except that the antistatic layer coating liquid (A) was replaced by the antistatic layer coating liquid (B).

### EXAMPLE 1-3

An optical film of Example 1-3 was prepared in the identical manner as in Example 1-1, except that the antistatic layer coating liquid (A) was replaced by the antistatic layer coating liquid (C).

### EXAMPLE 1-4

An optical film of Example 1-4 was prepared in the identical manner as in Example 1-1, except that the antistatic layer coating liquid (A) was replaced by the antistatic layer coating liquid (D).

### EXAMPLE 1-5

An optical film of Example 1-5 was prepared in the identical manner as in Example 1-1, except that the antistatic layer coating liquid (A) was replaced by the antistatic layer coating liquid (E).

### EXAMPLE 1-6

An optical film of Example 1-6 was prepared in the identical manner as in Example 1-1, except that the antistatic layer coating liquid (A) was replaced by the antistatic layer coating liquid (F).

### EXAMPLE 1-7

On a triacetyl cellulose film of a thickness of 80 μm and a width of 1340 mm (TAC-TD80U, manufactured by Fuji Photo Film Co., Ltd.), the aforementioned antistatic layer coating liquid (G) was coated with a die coating method. It was dried for 20 minutes at 100° C. to obtain an antistatic layer of a thickness of 0.2 μm.

Then, on the antistatic layer, a hard coat layer of a thickness of 2.5 μm was formed in the identical manner as in Example 1-1. In this manner an optical film of Example 1-7 was prepared.

### EXAMPLE 1-8

On a triacetyl cellulose film of a thickness of 80 μm and a width of 1340 mm (TAC-TD80U, manufactured by Fuji Photo Film Co., Ltd.), the antistatic layer coating liquid (H) was coated with a die coating method. It was dried for 150 seconds at 100° C., and the coated layer was cured, under a nitrogen purging (oxygen concentration of 0.5%), by an ultraviolet irradiation of an irradiation intensity of 400 mW/cm² and an irradiation amount of 300 mJ/cm² utilizing an air-cooled metal halide lamp of 160 W/cm (manufactured by Eyegraphics Co.) to obtain an antistatic layer of a thickness of 0.2 μm.

Then, on the antistatic layer, a hard coat layer of a thickness of 2.5 μm was formed in the identical manner as in Example 1-1. In this manner an optical film of Example 1-8 was prepared.

### EXAMPLE 1-9

On the antistatic layer prepared in Example 1-1, the hard coat layer coating liquid (II) was coated by a die coating method. After drying for 150 seconds at 100° C., the coated layer was cured, under a nitrogen purging (oxygen concentration of 0.1% or less), by an ultraviolet irradiation of an irradiation intensity of 400 mW/cm² and an irradiation amount of 250 mJ/cm² utilizing an air-cooled metal halide lamp of 160 W/cm (manufactured by Eyegraphics Co.) to obtain a hard coat layer of a thickness of 3.7 μm. In this manner an optical film of Example 1-9, having almost no antiglare property but having a light diffusing function for a transmitted light, was prepared.

### EXAMPLE 1-10

An optical film of Example 1-10, having almost no antiglare property but having a light diffusing function for a transmitted light, was prepared in the identical manner as in Example 1-9, except that the hard coat layer coating liquid (II) was replaced by the hard coat layer coating liquid (III).

### EXAMPLE 1-11

On the antistatic layer prepared in Example 1-2, the hard coat layer coating liquid (III) was coated by a die coating method. After drying for 150 seconds at 100° C., the coated layer was cured, under a nitrogen purging (oxygen concentration of 0.1% or less), by an ultraviolet irradiation of an irradiation intensity of 400 mW/cm² and an irradiation amount of 250 mJ/cm² utilizing an air-cooled metal halide lamp of 160 W/cm (manufactured by Eyegraphics Co.) to obtain a hard coat layer of a thickness of 3.7 μm. In this manner an optical film of Example 1-11, having almost no antiglare property but having a light diffusing function for a transmitted light, was prepared.

### EXAMPLE 1-12

An optical film of Example 1-12 was prepared in the identical manner as in Example 1-11, except that the antistatic layer was replaced by the antistatic layer prepared in Example 1-3.

### EXAMPLE 1-13

An optical film of Example 1-13 was prepared in the identical manner as in Example 1-11, except that the antistatic layer was replaced by the antistatic layer prepared in Example 1-4.

### EXAMPLE 1-14

An optical film of Example 1-14 was prepared in the identical manner as in Example 1-11, except that the antistatic layer was replaced by the antistatic layer prepared in Example 1-5.

### EXAMPLE 1-15

An optical film of Example 1-15 was prepared in the identical manner as in Example 1-11, except that the antistatic layer was replaced by the antistatic layer prepared in Example 1-6.

### EXAMPLE 1-16

An optical film of Example 1-16 was prepared in the identical manner as in Example 1-11, except that the antistatic layer was replaced by the antistatic layer prepared in Example 1-7.

### EXAMPLE 1-17

An optical film of Example 1-17 was prepared in the identical manner as in Example 1-11, except that the antistatic layer was replaced by the antistatic layer prepared in Example 1-8.

### EXAMPLE 1-18

On the antistatic layer prepared in Example 1-1, the hard coat layer coating liquid (IV) was coated by a die coating method. After drying for 150 seconds at 100° C., the coated layer was cured, under a nitrogen purging (oxygen concentration of 0.1% or less), by an ultraviolet irradiation of an irradiation intensity of 400 mW/cm² and an irradiation amount of 100 mJ/cm² utilizing an air-cooled metal halide lamp of 160 W/cm (manufactured by Eyegraphics Co.) to obtain a hard coat layer of a thickness of 5.5 μm. A surface roughness (Ra) of the hard coat layer, evaluated by an atomic force microscope (AFM), was 0.14 μm.

In this manner an optical film of Example 1-18, having an antiglare property, was prepared.

### EXAMPLE 1-19

An optical film of Example 1-19 having an antiglare property, was prepared in the identical manner as in Example 1-18, except that the antistatic layer was replaced by the antistatic layer prepared in Example 1-2.

### EXAMPLE 1-20

An optical film of Example 1-20 having an antiglare property, was prepared in the identical manner as in Example 1-19, except that the antistatic layer was replaced by the antistatic layer prepared in Example 1-3.

### EXAMPLE 1-21

An optical film of Example 1-21 having an antiglare property, was prepared in the identical manner as in Example 1-19, except that the antistatic layer was replaced by the antistatic layer prepared in Example 1-4.

### EXAMPLE 1-22

An optical film of Example 1-22 having an antiglare property, was prepared in the identical manner as in Example 1-19, except that the antistatic layer was replaced by the antistatic layer prepared in Example 1-5.

### EXAMPLE 1-23

An optical film of Example 1-23 having an antiglare property, was prepared in the identical manner as in Example 1-19, except that the antistatic layer was replaced by the antistatic layer prepared in Example 1-6.

### EXAMPLE 1-24

An optical film of Example 1-24 having an antiglare property, was prepared in the identical manner as in Example 1-19, except that the antistatic layer was replaced by the antistatic layer prepared in Example 1-7.

### EXAMPLE 1-25

An optical film of Example 1-25 having an antiglare property, was prepared in the identical manner as in Example 1-19, except that the antistatic layer was replaced by the antistatic layer prepared in Example 1-8.

### COMPARATIVE EXAMPLES

### Comparative Example 1-A

An optical film of Comparative Example 1-A was prepared in the identical manner as in Example 1-4, except that the antistatic layer coating liquid (D) was replaced by the antistatic layer coating liquid (I).

### Comparative Example 1-B

An optical film of Comparative Example 1-b was prepared in the identical manner as in Example 1-4, except that the antistatic layer coating liquid (D) was replaced by the antistatic layer coating liquid (J).

(Evaluation of Optical Film)

The optical films prepared in Examples 1-1 to 1-25 and Comparative Examples 1-A and 1-B were evaluated in the following items. Results are shown in Table 1.

(1) Evaluation of Adhesive Property

On a surface of the side having the antistatic layer, eleven notches were made with a cutter knife in longitudinal and lateral directions to form 100 squares, then an adhesion test with a polyester adhesive tape (No. 31B, manufactured by Nitto Denko Co.) was repeated two times in a same position and a peeling level was visually inspected and evaluated in following four levels:

AA: no peeling observed in all 100 squares;

A: peeling observed in 2 or less among 100 squares;

B: peeling observed in 3 to 10 among 100 squares;

C: peeling observed in more than 10 among 100 squares.

(2) Evaluation of Surface Resistivity

On a surface of the antistatic layer before coating of the hard coat layer and on a surface of the antistatic layer after coating of the hard coat layer, the surface resistivity was measured with a surface resistivity measuring instrument (TR8601, manufactured by Advantest Ltd.) under conditions of 25° C. and a relative humidity of 60%.

(3) Antidust Property

An optical film was adhered on a monitor, and dusts (fragments of clothing fibers) were sprinkled on the surface having the antistatic layer, simultaneous with the turning-on of the power supply of the monitor. The dusts were wiped off with a cleaning cloth, and the removability of the dusts was evaluated in following four levels:

AA: dusts removed completely;

A: dusts remaining very slightly;

B: dusts remaining in a certain level;

C: dusts remaining considerably.

(4) Evaluation of Scratch Resistance

On a surface of the optical film at the side of the antistatic layer, a rubbing test was conducted with steel wool.

Steel wool (manufactured by Nippon Steel Wool Co., grade No. 0000) was employed as a rubbing material, and a rubbing test was conducted under conditions of a moving distance (one-way) of 13 cm, a rubbing speed of 13 cm/sec, a load of 1.96 N/cm², a front end contact area of 1×1 cm, and 2 reciprocating rubbing cycles. Scratches on the surface were visually evaluated in following 4 levels:

AA: no scratches even under a careful observation;

A: slight scratches observable under careful observation;

B: weak scratches observable;

C: scratches evident even in simple observation.

(Results of Evaluation)

Results of evaluation on the samples are shown in Table 1.

TABLE 1

| | | Surface | | | |
|---|---|---|---|---|---|
| | | resistivity (Ω/sq) | | | |
| | | surface of | surface of | | |
| | Adhesion | antistatic | hard coat | antidust | scratch |
| | property | layer | layer | property | resistance |
| Example 1-1 | AA | 3.2 × 10⁶ | 1.1 × 10¹⁰ | A | AA |
| Example 1-2 | AA | 2.5 × 10⁶ | 9.2 × 10⁹ | A | AA |
| Example 1-3 | AA | 4.1 × 10⁶ | 2.0 × 10¹⁰ | A | AA |
| Example 1-4 | AA | 2.4 × 10⁶ | 9.0 × 10⁹ | A | AA |
| Example 1-5 | AA | 6.1 × 10⁶ | 2.8 × 10¹⁰ | A | AA |
| Example 1-6 | AA | 3.1 × 10⁷ | 2.4 × 10¹¹ | B | AA |
| Example 1-7 | AA | 3.0 × 10⁶ | 1.2 × 10¹⁰ | A | AA |
| Example 1-8 | AA | 3.7 × 10⁶ | 2.0 × 10¹⁰ | A | AA |
| Example 1-9 | AA | 3.2 × 10⁶ | 5.8 × 10¹¹ | B | AA |
| Example 1-10 | AA | 3.2 × 10⁶ | 1.5 × 10⁸ | AA | AA |
| Example 1-11 | AA | 2.5 × 10⁶ | 1.1 × 10⁸ | AA | AA |
| Example 1-12 | AA | 4.1 × 10⁶ | 3.8 × 10⁸ | AA | AA |
| Example 1-13 | AA | 2.4 × 10⁶ | 2.1 × 10⁸ | AA | AA |
| Example 1-14 | AA | 6.1 × 10⁶ | 5.2 × 10⁸ | AA | AA |
| Example 1-15 | AA | 3.1 × 10⁷ | 3.3 × 10⁹ | A | AA |
| Example 1-16 | AA | 3.0 × 10⁶ | 2.9 × 10⁸ | AA | AA |
| Example 1-17 | AA | 3.7 × 10⁶ | 3.5 × 10⁸ | AA | AA |
| Example 1-18 | AA | 3.2 × 10⁶ | 5.0 × 10⁸ | AA | AA |
| Example 1-19 | AA | 2.5 × 10⁶ | 4.7 × 10⁸ | AA | AA |
| Example 1-20 | AA | 4.1 × 10⁶ | 6.4 × 10⁸ | AA | AA |
| Example 1-21 | AA | 2.4 × 10⁶ | 4.5 × 10⁸ | AA | AA |
| Example 1-22 | AA | 6.1 × 10⁶ | 2.3 × 10⁹ | A | AA |
| Example 1-23 | AA | 3.1 × 10⁷ | 4.5 × 10¹⁰ | A | AA |
| Example 1-24 | AA | 3.0 × 10⁶ | 5.3 × 10⁸ | AA | AA |
| Example 1-25 | AA | 3.7 × 10⁶ | 6.2 × 10⁸ | AA | AA |
| Comp. Ex. 1-A | C | 1.1 × 10⁶ | 8.5 × 10⁷ | AA | AA |
| Comp. Ex. 1-B | AA | >1 × 10¹⁵ | >1 × 10¹⁵ | C | AA |

As will be apparent from the results shown in Table 1, the optical films of Examples 1-1 to 1-25, having the antistatic layer of the invention containing cellulose acylate were excellent in the adhesion property, antidust property and scratch resistance.

On the other hand, Comparative Example 1-A with an antistatic layer not containing cellulose acylate was inferior in the adhesion property. Also Comparative Example 1-B, not having the antistatic layer, was inferior in the antidust property. Also Comparative Example 1-C (TAC-TD80U), not having both the antistatic layer and the hard coat layer, was inferior both in the antidust property and the scratch resistance, though not shown in Table 1.

Also similar results were obtained, in the same evaluation, on samples in which the cellulose acetate employed in the antistatic layer coating liquid (A) or (B) was changed to a cellulose acetate (acetyl group substitution degree: 2.78, polymerization degree: 290) (cellulose triacetate). Also similar results were obtained when, in the ATO dispersion SNS-10M (manufactured by Ishihara Sangyo Co.), the conductive material contained therein was changed to tin-doped indium oxide (ITO, specific surface area: 40 m²/g) or to aluminum-doped zinc oxide (AZO, specific surface area: 50 m²/g). Furthermore, similar results were obtained when the solvent composition of the antistatic layer coating liquid was changed to dichloromethane/methanol 90/10 or dichloromethane/methanol/butanol=90/7/3.

### Comparative Example 1-D

In a commercially available dispersion of antimony-containing tin oxide (ATO) (SNS-10M, solid concentration 30 mass %, manufactured by Ishihara Sangyo Co.), the solvent replacement was conducted to obtain an ATO dispersion of a solid concentration of 30 mass % and a solvent composition of methyl isobutyl ketone/MEK=7/3 (mass ratio). To 87.6 parts by mass of the ATO dispersion, 11.4 parts by mass of a mixture of dipentaerythritol pentaacrylate and dipentaerythritol hexaacrylate (DPHA, manufactured by Nippon Kayaku Co.) and 1.0 parts by mass of a polymerization initiator (Irgacure 184, manufactured by Ciba Specialty Chemical Inc.) were added and agitated.

On a triacetyl cellulose film of a thickness of 80 μm and a width of 1340 mm (TAC-TD80U, manufactured by Fuji Photo Film Co., Ltd.), the hard coat layer coating liquid was coated with a die coating method. It was dried for 150 seconds at 100° C., and the coated layer was cured, under a nitrogen purging (oxygen concentration of 0.1% or less), by an ultraviolet irradiation of an irradiation intensity of 400 mW/cm² and an irradiation amount of 250 mJ/cm² utilizing an air-cooled metal halide lamp of 160 W/cm (manufactured by Eyegraphics Co.) to obtain a hard coat layer of a thickness of 2.5 μm. In this manner an optical film of Comparative Example 1-D was prepared.

In an evaluation as in Examples 1-1 to 1-25, the optical film of Comparative Example 1-D was excellent in the adhesion property, antidust property and scratch resistance. However, in comparison with the optical films of Examples 1-1 to 1-25, it was evidently colored (in dark blue color), and was inferior in the optical transmittance by 5% or more.

The hard coat layer with the antistatic property of Comparative Example 1-D was thicker than the antistatic layers in Examples 1-1 to 1-25, and contained a large amount of ATO. The coloration and the low optical transmittance in the optical film of Comparative Example 1-D result from a large amount of ATO contained in the hard coat layer, and the presence of the conductive material in the hard coat layer is therefore undesirable.

### EXAMPLE 2

### Preparation of Cellulose Acetate Dope (a)

A following composition was charged in a mixing tank equipped with agitating blades, and agitated under heating to obtain a cellulose acetate dope (a).

| | |
|---|---|
| methylene chloride | 59.2 parts by mass |
| methanol | 15.4 parts by mass |
| 1-butanol | 0.5 parts by mass |
| cellulose acetate powder (substitution degree: 2.84) | 22.4 parts by mass |
| triphenyl phosphate | 1.67 parts by mass |
| biphenyldiphenyl phosphate | 0.75 parts by mass |

### Preparation of UV Absorber Solution 1

A following composition was charged in another dissolving tank and dissolved under agitation to obtain a UV absorber solution 1.

| | |
|---|---|
| 2(2′-hydroxy-3′,5′-di-tert-butylphenyl)-benzotriazole | 7.65 parts by mass |
| 2(2′-hydroxy-3′,5′-di-tert-amylphenyl)-5- | 3.25 parts by mass |
| chlorobenzotriazole | |
| methylene chloride | 77.0 parts by mass |
| acetone | 11.6 parts by mass |
| 1-butanol | 0.5 parts by mass |

### Preparation of Cellulose Acetate Dope (b)

A following composition was charged in another dissolving tank and dissolved under agitation to obtain a cellulose acetate dope (b).

| | |
|---|---|
| cellulose acetate dope (a) | 98.0 parts by mass |
| UV absorber solution 1 | 2.0 parts by mass |

### Preparation of Fine Particle Dispersion 1

A following composition was charged in another dissolving tank and dissolved under agitation to obtain a fine particle dispersion 1.

| | |
|---|---|
| fine particles (SiO₂ (particle size 15 nm)) | 1.43 parts by mass |
| methylene chloride | 85.2 parts by mass |
| acetone | 12.8 parts by mass |
| 1-butanol | 0.6 parts by mass |

### Preparation of Cellulose Acetate Dope (c)

A following composition was charged in another dissolving tank and dissolved under agitation to obtain a cellulose acetate dope (c).

| | |
|---|---|
| cellulose acetate dope (a) | 93.0 parts by mass |
| fine particle dispersion 1 | 7.0 parts by mass |

### Preparation of Cellulose Acetate Dope (d)

A following composition was charged in another dissolving tank and dissolved under agitation to obtain a cellulose acetate dope (d).

| | |
|---|---|
| cellulose acetate dope (a) | 75.0 parts by mass |
| SNS-10M | 25.0 parts by mass |

### Preparation of Cellulose Acetate Dope (e)

A following composition was charged in another dissolving tank and dissolved under agitation to obtain a cellulose acetate dope (e).

| | |
|---|---|
| cellulose acetate dope (a) | 60.0 parts by mass |
| SNS-10M | 40.0 parts by mass |

### Preparation of Conductive Material Dispersion SNS-10MC

The aforementioned dispersion SNS-100M (solid concentration 30 mass %) of antimony-containing tin oxide (ATO) was distilled under a reduced pressure to obtain antimony-containing tin oxide of a solid concentration of 40 mass %, which is called SNS-10MC (solid concentration: 40 mass %).

### Preparation of Cellulose Acetate Dope (f)

A following composition was charged in another dissolving tank and dissolved under agitation to obtain a cellulose acetate dope (f).

| | |
|---|---|
| cellulose acetate dope (a) | 50.0 parts by mass |
| SNS-10MC | 50.0 parts by mass |

### Preparation of Co-Cast Substrate Samples 201-204

There was employed a casting die equipped with a feed block adjusted for a co-casting so as to form a film of two-layered structure, in which a sub-cast layer was laminated on a surface of a main cast layer. A band casting operation was conducted with the cellulose acetate dope (c) as a main cast layer and the cellulose acetate dope (d) as a sub cast layer, under a regulation of the extrusion amounts so as to obtain following thicknesses. The film was then dried with a drying air of 100° C. until the residual solvent became 10 mass %, and further dried for 10 minutes with a drying air of 130° C. In this manner, there was prepared a substrate sample 201 of a total thickness of 80 μm, with a main cast layer of a thickness of 78 μm and a sub cast layer of a thickness of 2 μm.

Also samples 202-204 were prepared by changing the types and combination of the dopes as shown in Table 2, from the sample 201. Compositions of the samples 201-204 are shown in Table 2.

TABLE 2

| | | | sub cast layer | |
|---|---|---|---|---|
| Substrate | main cast layer | | dope | |
| sample No. | dope type | thickness (μm) | type | thickness (μm) |
| 201 (invention) | c | 78 | d | 2 |
| 202 (invention) | c | 78 | e | 2 |
| 203 (comp. ex.) | c | 78 | f | 2 |
| 204 (comp. ex.) | c | 80 | none | none |

### Preparation of Co-Cast Substrate Samples 211-216

There was employed a casting die equipped with a feed block adjusted for a co-casting so as to form a film of three-layered structure, in which sub-cast layers were laminated on both surfaces of a main cast layer. A band casting operation was conducted with the cellulose acetate dope (b) as a main cast layer, the cellulose acetate dope (d) as a sub cast layer at a band side and the cellulose acetate dope (c) as a sub cast layer at an opposite air side, under a regulation of the extrusion amounts so as to obtain following thicknesses. The film was then dried with a drying air of 100° C. until the residual solvent content became 10 mass %, and further dried for 10 minutes with a drying air of 130° C. In this manner, there was prepared a substrate sample 211 of a total thickness of 80 μm, with a main cast layer of a thickness of 74 μm, a sub cast layer of the dope (d) of a thickness of 2 μm and a sub cast layer of the dope (c) of a thickness of 4 μm.

Also samples 212-216 were prepared by changing the types and combination of the dopes as shown in Table 3, from the sample 211. Compositions of the samples 211-216 are shown in Table 3.

TABLE 3

| | sub cast | | | | sub cast | |
|---|---|---|---|---|---|---|
| | layer (band | | main | | layer | |
| | side) | | cast layer | | (air side) | |
| substrate | dope | thickness | dope | thickness | dope | thickness |
| sample No. | type | (μm) | type | (μm) | type | (μm) |
| 211 (invention) | d | 2 | b | 74 | c | 4 |
| 212 (invention) | e | 2 | b | 74 | c | 4 |
| 213 (invention) | f | 2 | b | 74 | c | 4 |
| 214 (invention) | e | 2 | b | 76 | e | 2 |
| 215 (invention) | none | none | b | 76 | c | 4 |
| 216 (comp. | c | 2 | b | 74 | c | 4 |
| ex.) | | | | | | |

On the sub cast layer containing the conductive material, in each of the substrate samples 201-204 and 211-216 prepared in Example 2, the hard coat layer coating liquid in Example 1 was coated and cured in the same manner as in Example 1 to obtain optical film samples of Example 2.

Table 4 shows a combination of the substrate sample and the hard coat layer coating liquid. Also results of evaluation on these optical film samples in the same manner as in Example 1 are also shown in Table 4.

TABLE 4

| | | | | surface resistivity | | | |
|---|---|---|---|---|---|---|---|
| | | | | (Ω/sq.) | | | |
| | | hard | | surface of | | | |
| | subst. | coat | | conductive | surface of | | |
| | sample | coating | adhesion | layer of | hard coat | antidust | scratch |
| | No. | liq. No. | property | substrate | layer | property | resistance |
| Example 2-1 | 201 | IV | AA | 4 × 10⁸ | 3 × 10¹⁰ | AA | AA |
| Example 2-2 | 202 | IV | AA | 5 × 10⁷ | 6 × 10⁹ | AA | AA |
| Example 2-3 | 203 | IV | AA | 3 × 10⁶ | 4 × 10⁸ | AA | AA |
| Comp. Ex. 2-A | 204 | IV | AA | 6 × 10¹⁴ | 7 × 10¹⁴ | B | AA |
| Example 2-4 | 211 | IV | AA | 5 × 10⁸ | 5 × 10¹⁰ | AA | AA |
| Example 2-5 | 212 | IV | AA | 4 × 10⁷ | 3 × 10⁹ | AA | AA |
| Example 2-6 | 213 | IV | AA | 2 × 10⁶ | 3 × 10⁸ | AA | AA |
| Example 2-7 | 214 | IV | AA | 3 × 10⁶ | 5 × 10⁸ | AA | AA |
| Comp. Ex. 2-B | 215 | IV | AA | 4 × 10¹⁴ | 6 × 10¹⁴ | B | AA |
| Comp. Ex. 2-C | 216 | IV | AA | 3 × 10¹⁵ | 3 × 10¹⁵ | B | AA |
| Example 2-8 | 212 | II | AA | 5 × 10⁷ | 4 × 10⁹ | AA | AA |
| Example 2-9 | 212 | III | AA | 4 × 10⁷ | 5 × 10⁹ | AA | AA |

Results shown in Table 4 indicate that the cellulose acylate substrate samples having a sub cast layer containing the conductive material (Examples 2-1 to 2-3, 2-4 to 2-7, 2-8 and 2-9) were lower in the surface resistivity and better in the antidust property in comparison with comparative substrate samples (Comparative Examples 2-A to 2-C) not containing the conductive material.

### EXAMPLE 3

### Preparation of Hard Coat Layer Coating Liquid (V)

An antiglare hard coat layer coating liquid (V) was prepared in the same manner as the hard coat layer coating liquid (IV) in Example 1, except that 50 wt. % of the mixture of dipentaerythritol pentaacrylate and dipentaerythritol hexaacrylate (DPHA, manufactured by Nippon Kayaku Co.) therein was replaced by a polyester acrylate dendrimer (A) described in JP-A No. 2005-76005, Synthesis Example 1.

### Preparation of Optical Film

On the antistatic layer prepared in Example 1-1, the antiglare hard coat layer coating liquid (V) was coated and cured in the same manner as in Example 1-18 to obtain an optical film of Example 3-1.

### Evaluation of Optical Film

The optical film of Example 3-1, when evaluated on items same as in Example 1, showed excellent performances with an adhesion property AA, a surface resistivity of 4.2×10⁹ on the surface of the hard coat layer, an antidust property A and a scratch resistance AA. In addition the resin composition of this optical film showed a low curling and no crack formation.

### EXAMPLE 4

Results similar to those of Example 1 were obtained also in an optical film in which an antistatic layer was formed by a die coating method in the course, in a producing process of a cellulose triacetate film (TAC-TD80U, manufactured by Fuji Photo Film Co.), of a process from a casting to a winding, and then a hard coat layer was formed by another coating equipment. Also results similar to those of Example 1 were obtained in an optical film in which an antistatic layer and a hard coat layer were both formed by a die coating method in the course, in a producing process of a cellulose triacetate film (TAC-TD80U, manufactured by Fuji Photo Film Co.), of a process from a casting to a winding.

### EXAMPLE 5

### Preparation of Titanium Dioxide Fine Particle Dispersion

In 25.71 parts by mass of titanium dioxide fine particles containing cobalt (Co) (MPT-129C, manufactured by Ishihara Sangyo Co.), 4.11 parts by mass of a following dispersant and 70.18 parts by mass of cyclohexanone were added and the mixture was agitated by a disperser. The aforementioned fine particles of titanium dioxide contain cobalt (Co) in the interior of the titanium dioxide fine particles, and the surface of the fine particles is covered by an aluminum (Al) containing compound (oxide and/or hydroxide) and a zirconium (Zr) containing compound (oxide and/or hydroxide).

The titanium dioxide fine particles were dispersed in the liquid with a medium disperser (utilizing zirconia beads of a diameter of 0.1 mm). The titanium dioxide fine particles in the dispersion had a mass-averaged particle size of 68 nm, in a measurement by a light scattering method. A dispersion of titanium dioxide fine particles was obtained in this manner.

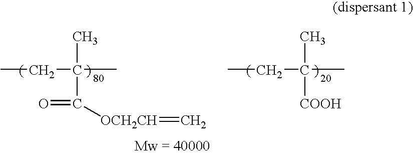

### Preparation of Medium Refractive Index Layer Coating Liquid

To 6.60 parts by mass of the dispersion of the titanium dioxide fine particles, 4.53 parts by mass of a mixture of dipentaerythritol pentaacrylate and dipentaerythritol hexaacrylate (DPHA, manufactured by Nippon Kayaku Co.), 0.24 parts by mass of a polymerization initiator (Irgacure 907, manufactured by Ciba Specialty Chemical Inc.), 0.08 parts by mass of a photosensitizer (Kayacure DETX-S, manufactured by Nippon Kayaku Co.) and 88.55 parts by mass of methyl ethyl ketone were added and agitated. The mixture was filtered with a polypropylene filter of a pore size of 0.4 μm to obtain a coating liquid for a medium refractive index layer.

### Preparation of High Refractive Index Layer Coating Liquid

To 31.29 parts by mass of the dispersion of the titanium dioxide fine particles, 2.67 parts by mass of a mixture of dipentaerythritol pentaacrylate and dipentaerythritol hexaacrylate (DPHA, manufactured by Nippon Kayaku Co.), 0.22 parts by mass of a polymerization initiator (Irgacure 907, manufactured by Ciba Specialty Chemical Inc.), 0.08 parts by mass of a photosensitizer (Kayacure DETX-S, manufactured by Nippon Kayaku Co.) and 65.74 parts by mass of methyl ethyl ketone were added and agitated. The mixture was filtered with a polypropylene filter of a pore size of 0.4 μm to obtain a coating liquid for a high refractive index layer.

### Synthesis of Perfluoroethylene Copolymer

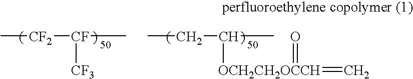

(50:50 means mole ratio.)

In an autoclave equipped with a stainless steel agitator, 40 parts by mass of ethyl acetate, 14.7 parts by mass of hydroxyethyl vinyl ether and 0.55 parts by mass of dilauroyl peroxide were charged, and the system was degassed and replaced with nitrogen gas. Then 25 parts by mass of hexafluoropropylene (HFP) were added to the autoclave, which was then heated to 65° C. The autoclave showed an internal pressure of 529.2 kPa when the internal temperature reached 65° C. A reaction was conducted for 8 hours at such temperature, then the heating was terminated when the pressure reached 313.6 kPa and the autoclave was let to cool. When the internal temperature was lowered to the room temperature, the unreacted monomer was expelled, then the autoclave was opened and the reaction liquid was taken out.

The obtained reaction liquid was added to hexane of a large excess amount, and the solvent was removed by decantation to recover precipitated polymer. The polymer was dissolved in a small amount of ethyl acetate and reprecipitated twice from hexane thereby completely eliminating the residual monomer. 28 parts by mass of a polymer product were obtained after drying.

20 parts by mass of the polymer product were dissolved in 100 parts by mass of N,N-dimethylacetamide, then 11.4 parts by mass of acrylic chloride were dropwise added, and the mixture was agitated for 10 hours at the room temperature. The reaction liquid was added with ethyl acetate, and washed with water, and an organic layer was extracted and concentrated. An obtained polymer was reprecipitated from hexane to obtain 19 parts by mass of the aforementioned perfluoroolefin copolymer, which had a refractive index of 1.421.

The perfluoroolefin copolymer was dissolved in methyl ethyl ketone to obtain a solution of a solid concentration of 30 mass %.

### Preparation of Low Refractive Index Layer Coating Liquid

To 15.0 parts by mass of the solution (solid concentration: 30 mass %) of the perfluoroethylene copolymer, 0.15 parts by mass of a polysiloxane compound having an acryloyl group (X-22-164C, manufactured by Shin-etsu Chemical Co.), 0.23 parts by mass of a polymerization initiator (Irgacure 907, manufactured by Ciba Specialty Chemical Inc.), 81.82 parts by mass of methyl ethyl ketone and 2.8 parts by mass of cyclohexanone were added and agitated. The mixture was filtered with a polypropylene filter of a pore size of 0.4 μm to obtain a coating liquid for a low refractive index layer.

### Preparation of Optical Film

On the hard coat layer prepared in Examples 1 to 4, the medium refractive index layer coating liquid was coated by a microgravure coating method. After drying for 60 seconds at 100° C., the coated layer was cured, under a nitrogen purging (oxygen concentration of 0.3% or less), by an ultraviolet irradiation of an irradiation intensity of 400 mW/cm² and an irradiation amount of 400 mJ/cm² utilizing an air-cooled metal halide lamp of 240 W/cm (manufactured by Eyegraphics Co.) to obtain a medium refractive index layer (refractive index: 1.63, thickness: 67 nm).

On the medium refractive index layer, the high refractive index layer coating liquid was coated by a microgravure coating method. After drying for 60 seconds at 100° C., the coated layer was cured, under a nitrogen purging (oxygen concentration of 0.1% or less), by an ultraviolet irradiation of an irradiation intensity of 400 mW/cm² and an irradiation amount of 600 mJ/cm² utilizing an air-cooled metal halide lamp of 240 W/cm (manufactured by Eyegraphics Co.) to obtain a high refractive index layer (refractive index: 1.90, thickness: 107 nm).

On the high refractive index layer, the low refractive index layer coating liquid was coated by a microgravure coating method. After drying for 150 seconds at 120° C., the coated layer was cured, under a nitrogen purging (oxygen concentration of 0.1% or less), by an ultraviolet irradiation of an irradiation intensity of 400 mW/cm² and an irradiation amount of 900 mJ/cm² utilizing an air-cooled metal halide lamp of 240 W/cm (manufactured by Eyegraphics Co.) to obtain a low refractive index layer (outermost layer) (refractive index: 1.43, thickness: 87 nm). In this manner an optical film of Example 4 having an antireflective property, was prepared.

(Evaluation of Optical Film)

On thus prepared optical film, a spectrophotometer (V-550, ARV-474, manufactured by Jasco Corp.) was used to measure a spectral reflectance, at an incident angle of 5°, within a spectral region of 380-780 nm, and an average reflectance in a wavelength region of 450-650 nm was determined. In all the optical films, the reflectance was lower than an average reflectance of about 4% in a glass plate and than an average reflectance of about 4% in a cellulose triacetate film (TAC-TD80U).

Also in an evaluation on the optical films of Example 5 in the same manner as in Example 1, the samples of the invention provided results similar to those in Examples 1 to 4, with a low surface resistivity, an excellent antidust property and a satisfactory scratch resistance.

### EXAMPLE 6

### Preparation of Organosilane Compound B Solution

In a reactor equipped with an agitator and a reflux condenser, 120 parts by mass of methyl ethyl ketone, 100 parts by mass of 3-acryloxypropyl trimethoxysilane (KBM-5103, manufactured by Shin-etsu Chemical Co.) and 3 parts by mass of diisopropoxy aluminum ethylacetacetate (trade name: Chelope EP-12, manufactured by Hope Chemical Co.) were added and mixed, then 30 parts by mass of ion-exchanged water were added and a reaction was conducted for 4 hours at 60° C. The reaction mixture was cooled to the room temperature to obtain a solution of an organosilane compound B (solid concentration: 29 mass %). It had a mass-averaged molecular weight of 1,600, and, within components equal to or larger than oligomer components, components with a molecular weight of 1,000-20,000 represented 100%. Also in a gas chromatography analysis, 3-acryloxypropyltrimethoxysilane utilized as the raw material scarcely remained.

### Preparation of Low Refractive Index Layer Coating Liquid 6 L

To 52.5 parts by mass of a thermally crosslinkable fluorine-containing polymer of a refractive index of 1.44 (JTA113, solid concentration: 6 mass %, manufactured by JSR Corp.), 4.5 parts by mass of an MEK dispersion of silica fine particles (MEK-ST, average particle size: 30 nm, solid concentration: 30 mass %, manufactured by Nissan Chemical Co.), 1.5 parts by mass of the aforementioned organosilane compound B solution, 38.5 parts by mass of methyl ethyl ketone and 3.0 parts by mass of cyclohexanone were added and agitated. The mixture was filtered with a polypropylene filter of a pore size of 0.4 μm to obtain a coating liquid 6 L for a low refractive index layer.

### Preparation of Optical Film

On the hard coat layer prepared in Examples 1 to 4, the medium refractive index layer coating liquid was coated by a microgravure coating method.

After drying for 150 seconds at 120° C., the coated layer was further dried for 10 minutes at 140° C. and was cured, under a nitrogen purging (oxygen concentration of 0.1% or less), by an ultraviolet irradiation of an irradiation intensity of 400 mW/cm² and an irradiation amount of 900 mJ/cm² utilizing an air-cooled metal halide lamp of 240 W/cm (manufactured by Eyegraphics Co.) to obtain a low refractive index layer (refractive index: 1.45, thickness: 95 nm). In this manner, an optical film having an antireflective property of Example 6 was prepared.

(Evaluation of Optical Film)

An average reflectance was determined on thus prepared optical film in the same manner as in Example 5. In all the optical films, the reflectance was lower than an average reflectance of about 4% in a glass plate and than an average reflectance of about 4% in a cellulose triacetate film (TAC-TD80U).

Also in an evaluation on the optical films of Example 6 in the same manner as in Example 1, there was obtained, on each item of evaluation, a result similar to those in Examples 1-5.

### EXAMPLE 7

A low refractive index layer coating liquid of Example 7 was prepared in the same manner as in Example 6, except that the materials therein were replaced as follows.

### Preparation of Low Refractive Index Layer Coating Liquid 7 L

80 parts by mass of a thermally curable fluorine-containing polymer described in JP-A No. 11-189621, Example 1, 20 parts by mass of Scimel 303 (manufactured by Nippon Scitec Industries Co.) and 2.0 parts by mass of Catalyst 4050 (manufactured by Nippon Scitec Industries Co.) were dissolved in methyl ethyl ketone so as to obtain a solid concentration of 6 mass %.

### Preparation of Optical Film

An optical film was prepared in the same manner as in Example 6.

(Evaluation of Optical Film)

An average reflectance was determined on thus prepared optical film in the same manner as in Example 6. In all the optical films, the reflectance was lower than an average reflectance of about 4% in a glass plate and than an average reflectance of about 4% in a cellulose triacetate film (TAC-TD80U).

Also in an evaluation on the optical films of Example 7 in the same manner as in Example 1, there was obtained, on each item of evaluation, a result similar to those in Examples 1-6.

### EXAMPLE 8

(Evaluation of Image Display Apparatus)

An optical film prepared in Examples 1-7 was mounted on a display surface of an image display apparatus (a liquid display apparatus of transmission, reflective or semi-transmission type of TN, STN, IPS, VA or OCB mode, a plasma display panel (PDP), an electroluminescence display (ELD) or a cathode ray tube (CRT)).

The image display apparatus mounted with the optical film of the invention was excellent in an adhesion property, an antidust property and a scratch resistance. In particular, the image display apparatus mounted with the optical film prepared in Example 5 or 6 also showed an excellent antireflective property and provided an extremely good visibility.

Also the image display apparatus mounted with an optical film having a hard coat layer showing a light diffusing function to the transmitted light exhibited, by the light diffusing effect for the transmitted light by the particles of 0.2 μm or larger contained in the hard coat layer, a particularly wide viewing angle in the vertical and lateral direction of the image display apparatus, thus providing an excellent visibility.

Also the image display apparatus mounted with an optical film having a hard coat layer showing an antiglare function exhibited an improvement in preventing a reflection of the external light (antiglare property), thus providing an excellent visibility.

### EXAMPLE 9

### Preparation of Protective Film for Polarizing Plate

A saponifying solution was prepared by maintaining a 1.5 mol/L aqueous solution of sodium hydroxide at 50° C. Also a 0.005 mol/L aqueous solution of sulfuric acid was prepared.

In the optical films prepared in Examples 1-6, a surface of the transparent substrate, opposite to the side of the antistatic layer of the invention, was saponified with the saponifying solution.

On the saponified surface of the transparent substrate, the aqueous solution of sodium hydroxide present thereon was sufficiently washed off by rinsing with water, and further washed with the aforementioned dilute aqueous solution of sulfuric acid, which was then sufficiently washed off with water, and the surface was sufficiently dried at 100° C.

The saponified surface of the transparent substrate, opposite to the side of the antistatic layer of the invention, had a contact angle to water of 40° or less. In this manner a protective film for a polarizing plate was prepared.

### Preparation of Polarizing Plate

A polyvinyl alcohol film of a thickness of 75 μm (manufactured by Kuraray Co.) was immersed in an aqueous solution formed by 1000 parts by mass of water, 7 parts by mass of iodine and 105 parts by mass of potassium iodide for 5 minutes to execute an iodine adsorption. Then the film was monoaxially extended by 4.4 times in the longitudinal direction, in a 4 mass % aqueous solution of boric acid, and was dried under a tensioned state to obtain a polarizing film.

A saponified triacetyl cellulose surface of the protective film for the polarizing plate was adhered, with an polyvinyl alcohol-based adhesive, to a surface of the polarizing film. On the other surface of the polarizing film, a cellulose triacetate (TAC) film saponified in a similar manner was adhered with a same polyvinyl alcohol-based adhesive.

(Evaluation of Image Display Apparatus)

A liquid crystal display apparatus of transmission, reflective or semi-transmission type of TN, STN, IPS, VA or OCB mode, mounted with thus prepared polarizing plate, was excellent in an adhesion property, an antidust property and a scratch resistance. In particular, the polarizing plate having the optical film prepared in Examples 5-7 showed an excellent antireflective property and provided an extremely good visibility.

Also the image display apparatus, mounted with a polarizing plate utilizing an optical film including a hard coat layer with a light diffusing function to the transmitted light, exhibited, by the light diffusing effect for the transmitted light by the particles of 0.2 μm or larger contained in the hard coat layer, a particularly wide viewing angle in the vertical and lateral direction of the liquid crystal display apparatus, thus providing an excellent visibility.

Also the image display apparatus, mounted with a polarizing plate utilizing an optical film provided with a hard coat layer having an antiglare function, exhibited an improvement in preventing a reflection of the external light (antiglare property), thus providing an excellent visibility.

Also similar results were obtained in polarizing plates, prepared in a similar manner with already known polarizing films.

### EXAMPLE 10

### Preparation of Polarizing Plate

A surface of an optical compensation film (Wide View film SA12B, manufactured by Fuji Photo Film Co.), opposite to a side having an optical compensation layer, was saponified under conditions similar to those in Example 9.

A saponified triacetyl cellulose surface of the protective film for the polarizing plate, prepared in Example 6, was adhered, with an polyvinyl alcohol-based adhesive, to a surface of the polarizing film prepared in Example 9. On the other surface of the polarizing film, a saponified triacetyl cellulose surface of the optical compensation film was adhered with a same polyvinyl alcohol-based adhesive.

(Evaluation of Image Display Apparatus)

A liquid crystal display apparatus of transmission, reflective or semi-transmission type of TN, STN, IPS, VA or OCB mode, mounted with thus prepared polarizing plate, was superior to a liquid crystal display apparatus mounted with a polarizing plate not utilizing an optical compensation film, in an image contrast in a bright room, also showed a very wide viewing angle in the vertical and lateral direction, and was excellent in an adhesion property, an antidust property and a scratch resistance. In particular, the polarizing plate having the optical film prepared in Examples 4 and 5 showed an excellent antireflective property and provided an extremely good visibility.

Also the image display apparatus, mounted with a polarizing plate utilizing an optical film provided with a hard coat layer with a light diffusing function to the transmitted light, exhibited, by the light diffusing effect for the transmitted light by the particles of 0.2 μm or larger contained in the hard coat layer, a particularly wide viewing angle in the vertical and lateral direction of the liquid crystal display apparatus, and also showed an improvement in a yellowish display in the lateral direction.

Also the image display apparatus, mounted with a polarizing plate utilizing an optical film provided with a hard coat layer having an antiglare function, exhibited an improvement in preventing a reflection of the external light (antiglare property), thus providing an excellent visibility.

Also similar results were obtained in polarizing plates, prepared in a similar manner with already known polarizing films.

### EXAMPLE 11

Optical films prepared in Examples 1-7, when mounted on an organic EL display apparatus, provided excellent results in an adhesion property, an antidust property and a scratch resistance. In particular, the image display apparatus mounted with the optical film prepared in Example 5-7 was excellent in an antireflective property and provided an extremely satisfactory visibility.

Also a polarizing plate, provided on a surface thereof with a protective film for the polarizing plate prepared in Example 6, and on the other surface with a λ/4 plate, was prepared in the same manner as in Example 9. Such polarizing plate, when mounted on an organic EL display apparatus, could cut off also a light reflection from a glass surface on which the polarizing plate was adhered, thereby providing a display apparatus of an extremely high visibility.

The optical film of the present invention, by containing a conductive material and cellulose acylate in the antistatic film, by inter alia letting an antistatic film be a part of a substrate or forming an antistatic film between a transparent substrate constituted of cellulose acylate and a hard coat film, shows an excellent mutual adhesion among the antistatic film and the hard coat film, and has excellent physical properties such as an antidust property and a scratch resistance. Also the optical film of the invention can be mass produced inexpensively, by a method of preparing an antistatic film or an antistatic film and a hard coat film within a process from a casting step of forming a transparent substrate to a winding step.

The entire disclosure of each and every foreign patent application from which the benefit of foreign priority has been claimed in the present application is incorporated herein by reference, as if fully set forth.

1. An optical film including an antistatic film comprising at least an electroconductive material and cellulose acylate.

2. An optical film according to claim 1,
wherein the antistatic film is laminated on a transparent substrate principally comprising cellulose acylate.

3. An optical film according to claim 1,
wherein the antistatic film is laminated by a co-casting method as a part of a substrate principally comprising cellulose acylate.

4. An optical film according to claim 1,
wherein the antistatic film and a hard coat film are laminated in this order on a transparent substrate principally comprising cellulose acylate.

5. An optical film according to claim 1, wherein a hard coat film is laminated on the antistatic film and comprises conductive particles of an average particle size of 0.2 to 10 μm.

6. An optical film according to claim 2,
wherein the antistatic film is laminated by a coating method selected from a wire bar coating, a gravure coating and a die coating.

7. An optical film according to claim 1,
wherein the optical film is an antistatic film, an antiglare film, a light diffusing film or an antireflection film.

8. An optical film according to claim 1,
wherein a surface of the optical film at the side of the antistatic film has a surface resistivity equal to or less than 1×10¹⁴ Ω/sq.

9. An optical film according to claim 4,
wherein the hard coat film comprises an ethylenic unsaturated group-containing polyester dendrimer (A), which is a reaction product of a polyester polyol dendrimer compound (a) having 6 or more hydroxyl groups in a molecule and an ethylenic unsaturated group-containing monocarboxylic acid (b), by 10 to 80 mass % calculated as a solid content.

10. An optical film producing method of producing an optical film according to claim 1.

11. A polarizing plate comprising:
a polarizing film; and
two protective films provided on both sides of the polarizing film,
wherein an optical film according to claim 1 is employed as at least one of the protective films.

12. A polarizing plate, comprising:
a polarizing film; and
two protective films provided on both sides of the polarizing film,
wherein an optical film according to claim 1 is employed as one of the protective films and an optical compensation film having an optically anisotropic layer is employed as the other of the protective films.

13. An image display apparatus comprising:
an image display surface; and
an optical film according to claim 1 provided on the image display surface.

14. An image display apparatus according to claim 13,
wherein the image display apparatus is a transmission type, reflective type or semi-transmission type liquid crystal display apparatus of TN, STN, IPS, VA or OCB mode.

15. An image display apparatus comprising:
an image display surface; and
a polarizing plate according to claim 11 provided on the image display surface.

16. An image display apparatus according to claim 15,
wherein the image display apparatus is a transmission type, reflective type or semi-transmission type liquid crystal display apparatus of TN, STN, IPS, VA or OCB mode.
